(19) United States
(12) Patent Application Publication
(10) Pub. No.: US 2007/0037711 A1
(43) Pub. Date: Feb. 15, 2007

(54) Film Forming Spreading Agents

(75) Inventors: Richard C. Pluta, Towaco, NJ (US); David Michael Glenn, Shepherdstown, WV (US); Gary Puterka, Stillwater, OK (US); John T. Mosko, Perth Amboy, NJ (US)

Correspondence Address: BASF CATALYSTS LLC, 101 WOOD AVENUE, ISELIN, NJ, 08830, US

(73) Assignee: Engelhard Corporation, Iselin, NJ (US)

(21) Appl. No.: 11/463,883

(22) Filed: Aug. 10, 2006

Related U.S. Application Data
(60) Provisional application No. 60/595,862, filed on Aug. 11, 2005.

(51) Int. Cl. A01N 25/10

(52) U.S. Cl. 504/358; 504/360

(57) ABSTRACT

The present composition comprises: (a) 99.80% by weight or less of at least one particle; (b) film forming spreading agent present in an amount of: (i) equal to or greater than 0.20% by weight if a spreader inhibitor is not present or (ii) equal to or greater than about 0.35% by weight if a spreader inhibitor is present; and optionally (c) at least one volumization agent. The present composition may be used in agricultural compositions and in non-agricultural uses.

This patent application claims priority to U.S. provisional patent application Ser. 60/595862 filed Aug. 11, 2005 incorporated herein by reference in its entirety.

### BACKGROUND OF THE INVENTION

The importance of agriculture to the economy cannot be overstated. To foster strong agricultural production, a myriad of treatments for agricultural substrates exist. Such treatments are diverse and include pesticides, growth promoters, fertilizers, and the like. Increasing the effectiveness of these treatments is desirable as agricultural production is facilitated.

Agricultural treatment substrates are both hydrophobic and hydrophilic surfaces and these two groups are defined by the contact angle of a sessile droplet resting on the target surface. Target surfaces are considered hydrophilic when the contact angle of a water droplet is less than 90° and considered hydrophobic when the contact angle is greater than 90°.

The problems associated with the application of liquids to hydrophobic and hydrophilic surfaces are well known.

Applications of liquids to hydrophobic surfaces are problematic as these surfaces repel aqueous-based sprays. This is usually remedied by use of a surfactant. However, depositions with surfactants can be too thin and can run off hydrophobic surfaces and, in addition, can be extremely thin and have extreme run off of co-targeted hydrophilic surfaces. Thus, in terms of hydrophilic surfaces, conventional agricultural surfactants (spreaders) can overspread and cause extreme runoff resulting in poor coverage.

The application of liquids to hydrophilic surfaces poses fewer problems because these surfaces readily wet. The main problem encountered with applying liquids to hydrophilic surfaces is the phenomenon known as over-wetting that results in overspreading and can cause approximately two-thirds of the spray material to run off the surface and be wasted. Reducing spray volumes will generally reduce, but not eliminate, this problem.

These problems are also seen in the delivery of agricultural particle films. There are two techniques currently used to improve delivery of particles to target surfaces. One is the retention of the treatment on the plant surface by the use of stickers. The second factor is the use of spreaders to improve coverage of the treatment. These arts can enhance spray retention on hydrophobic surfaces but overspreading and droplet retraction occurs which leads to the problem of thin, spotty deposits and/or non-uniform film formation.

Stickers are materials that increase the retention of sprays on plants by improving adhesion to the substrate and resisting various environmental factors. A sticker is further defined as a substance which increases the firmness of attachment of spray emulsions, active ingredients, water soluble materials, liquid chemicals, finely-divided solids or other water-soluble or water-insoluble materials to a solid surface, and which may be measured in terms of resistance to time, wind, water, mechanical or chemical action. Typically, stickers are substances such as latex or other adhesives that improve attachment of an active ingredient to sprayed surfaces. For example, in pesticidal compositions, stickers protect the active pesticide ingredient from wash-off due to rainfall, heavy dew or irrigation, and help prevent pesticide loss from wind or leaf abrasion.

A sticker may be further defined as a material which increases spray droplet retention to a substrate by facilitating droplet capture and thereby preventing the material from rolling off, blowing off, deflecting, shattering, or otherwise reducing the amount of spray material which remains in contact on the substrate during moment of deposition until the time which the spray droplet has chance to dry.

A conventional agricultural spreader is a substance which increases the area that a given volume of liquid covers. Spreaders may function by reducing the surface tension of spray droplets, increasing surface wetting, and/or enhancing coverage, increasing droplet spray retention. For example, use of anionic spreader on a plant may increase the resistance of an active material to removal by rain, dew, or irrigation. Anionic spreaders also prevent the active ingredient from being readily absorbed through plant cuticles and such materials are, therefore, used when the effectiveness of the active material depends upon it remaining on the outer surface of the plant. Alternatively, non-ionic spreaders can be used to increase the transport of an active material through plant cuticles and are, therefore, recommended for use with systemic herbicides, pesticides, nutrients and the like.

Generally speaking, currently available spreaders are of limited utility due to specific, well-defined problems, most of which are related to retention deficiencies, overspreading, lack of film-forming ability commonly referred to herein as spotting, insufficient development of deposited spray volume, retention of deposited spray volume and film thickness, incompatibility with the surface, and/or incompatibility with the active ingredient or other components of the solution or slurry. For example, spreaders in agricultural sprays typically function in their intended manner when used with specific active ingredient chemistry and/or for specific substrates.

The problems of delivering materials to hydrophobic surfaces is not just limited to liquids but also encompasses uneven application of coatings by creams or pastes because the lack of physiochemical binding which results in uneven films due to retraction and repulsion between the solution or slurry and the target surface. The ability of stickers and spreaders or traditional and nontraditional surfactants to universally coat surfaces is limited by their chemistry and physical dynamics. Therefore, there is a need for spreaders that do not rely on traditional or nontraditional surfactant properties of ionization and/or dissociation with water that dictates and thereby limits their functionality as spreaders on target surfaces.

SURROUND® WP crop protectant is labeled as 95% kaolin and 5% other ingredients. The specimen label discloses that initial application over waxy surfaces such as mango fruit may not spread and instructs the user: See Engelhard supplemental labeling for further information on use of spreaders. Commonly assigned U.S. Pat. No. 6,514,512 teaches that SURROUND® WP crop protectant is calcined kaolin with an organic spreader/sticker. However, in commercial usage and as seen when we applied SURROUND® WP crop protectant as shown in FIGS. 16 (left column) and 21, we observe that film-forming spreading (defined below) did not occur on hydrophobic surfaces such as apples.

There is a need for spreading and sticking agents that have relatively equal deposition properties on both hydrophobic and hydrophilic surfaces. This is particularly needed in plants that have both hydrophobic and hydrophilic surfaces such as tomatoes and grapes wherein generally the fruit is hydrophobic and the foliage is hydrophilic. In such a case, a given level of conventional spreaders may be ideal for the hydrophobic part of the plant, but may induce overspreading on the hydrophilic part of the plant.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Rather, the sole purpose of this summary is to present some concepts of the invention in a simplified form as a prelude to the more detailed description that is presented hereinafter.

The present composition comprises: (a) 99.80% by weight or less of at least one particle; (b) film forming spreading agent present in an amount of: (i) equal to or greater than 0.20% by weight if a spreader inhibitor is not present or (ii) equal to or greater than about 0.35% by weight if a spreader inhibitor is present; and optionally (c) at least one volumization agent.

The present invention provides a composition comprising: (a) 99.65% by weight or less of at least one particle; and (b) greater than 0.35% by weight of high molecular weight polyvinyl compound having an average molecular weight of at least about 85,000 Daltons or a minimum viscosity of about 25 to 50 centipoises ±5 centipoises measured at 4 percent w/w polyvinyl alcohol concentration in water and optionally (c) at least one volumization agent such as animal glue.

The present invention facilitates delivering continuous and semi-continuous films of materials from sprays by employing specified amounts of high molecular weight water-soluble hydroxypolymer compounds containing lipophilic side functional groups, for example, certain polyvinyl compounds and modified high molecular weight complex carbohydrates.

A key advantage of the present film-forming spreading agent is that they are available as dry relatively pure powders whereas virtually all conventional spreaders are available only as liquids.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed.

### BRIEF DESCRIPTION OF THE DRAWINGS

FIGS. 1 through 11 represent idealized operation of known compositions and the present compositions.

FIGS. 12 through 26 are photographs of various surfaces having known compositions and the present compositions thereon.

### DETAILED DESCRIPTION OF THE INVENTION

The term “spreading” as used herein means a method to increase the area that a given volume of liquid covers a substrate.

The term “spreading agent” as used herein means an agent that achieves spreading as defined herein.

The term “film forming spreading” as used herein means a type of spreading that also builds films having increased fluid volume retention and thus increased solids deposition on similarly both hydrophilic and hydrophobic surfaces.

The term “film forming spreading agent” as used herein means a spreading agent that also builds films having increased fluid volume retention and thus increased solids deposition similarly on both hydrophilic and hydrophobic surfaces.

The term “sticker” as used herein means a material that increases the adhesion of sprays on plants by resisting various environmental factors. A sticker may also increase the firmness of attachment of spray emulsions, active ingredients, water soluble materials, liquid chemicals, finely-divided solids or other water-soluble or water-insoluble materials to a solid surface, and which may be measured in terms of resistance to time, wind, water, mechanical or chemical action.

A sticker may be further defined as a material which increases spray droplet retention to a substrate by facilitating droplet capture and thereby preventing the material from rolling off, blowing off, deflecting, shattering, or otherwise reducing the amount of spray material which remains in contact on the substrate during moment of deposition until the time which the spray droplet has chance to dry.

The term “flock” or “flocking” as used herein means using physical or chemical means to achieve an association of individual particles in the wet or dry state. This effect is known as flocculation.

The term “flocked” as used herein means an association of two or more individual particles in the wet or dry state.

The term “volumized” as used herein means an increased separation of a given mass of particles. Volumized usually results from structuring as defined above or may also result from increasing viscosity and/or surface tension. In most cases, this means that the resultant dried deposition, wet deposition, deposition droplet or wet sediment has a greater volume than the same deposition that is not volumized. Volumized also means that depositions are higher and thicker in the liquid state (before drying).

The phrase “volumization agent” as used herein means any agent capable of constructing a volumized system.

The term “structure” or “structuring” as used herein means having the ability to cause individual particles to form flocks, agglomerates, aggregates, and/or associations that can cause a system to be volumized upon drying and thereby construct a functional deposition.

The phrase “structuring agent” as used herein means any agent capable of causing structuring.

The term “structured” as used herein means two or more individual particles that have formed flocks, agglomerates, aggregates, and/or are otherwise associated that cause a system to be volumized.

The word “film” as used herein means a wet or dry coating that is continuous or if semi-continuous, is acceptable for use. The phrase “particle film” as used herein means a film composed substantially of particles.

The term “retraction” as used herein refers the physical action of the droplet as it shrinks either upon sitting or when the water or fluid from the droplet dries.

The term “cross-links” as used herein means covalent bonds linking one polymer chain to another. Crosslinking inhibits close packing of the polymer chains, preventing the formation of crystalline regions. The restricted molecular mobility of a crosslinked structure limits the extension of the polymer material under loading. Cross-links are formed by chemical reactions that are commonly initiated by heat and/or pressure, or by the simple mixing of an unpolymerized, partially polymerized or fully polymerized resin or compound with various chemicals; cross-linking can also be induced in materials that are normally thermoplastic through exposure to radiation

The phrase “cross-linkable polymeric film” as used herein means a coating or film that has at least one or more of its ingredients cross-linked by use of a cross-linking agent. A cross-linking agent by this definition may also cross-link two entirely different compounds. Cross-linking also increases the molecular weight of the ingredient and can make the ingredient insoluble.

Film-Forming Spreading Agents:

The invention relates to methods of delivering continuous or semi-continuous films of materials from slurries or solutions by adding specified amounts of film-forming spreading agent(s) such as high molecular weight water-soluble hydroxypolymer compounds containing lipophilic side chains. These include, for example certain polyvinyl compounds and modified high molecular weight complex carbohydrates. These materials not only function as polymers to prevent droplet rebound but the lipophilic side groups on the hydroxypolymer compounds interact with the lipophilic target surface and physiochemically attach the droplet as it spreads upon impact to prevent droplet rebound and achieved uniform film-forming spreading on hydrophobic surfaces. The presence of at least one film-forming spreading agent such as high molecular weight water soluble hydroxypolymer compound in the specified amount ensures uniform and idealized spreading over a variety of target surfaces, independent of the chemical composition of the pesticide or other active ingredient(s) in the slurry or solution and independent to the chemistry and morphology of the target surface. The high molecularweightwater-soluble hydroxypolymer compounds and the active ingredient can be incorporated into dry mixtures, wet mixtures such as emulsions, slurries, creams or pastes.

Film-forming spreading on hydrophobic surfaces can thus be achieved by non-traditional HLB relationships that do not follow the distinct hydrophilic-lipophilic balance or have a molecule with a distinct head and tail arrangement. Certain polymers and synthetic surfactants can arrange themselves with the active ingredients of a solution or slurry, or with the target surface to form macromolecules that have hydrophilic and lipophilic moieties that can further reduce surface tension and enhance film-forming spreading upon target surfaces. Another way of stating this is that polymers, having sufficient chain length and hydrophobic moiety will allow greater compatibility with hydrophobic surfaces thus having lipophilic/lipophilic interaction with a hydrophobic substrate and thereby improve film formation and spreading. Furthermore, the incorporation of thread-like polymer compounds into solutions or slurries can uncoil and absorb the shock of the droplet when it hits a surface to control the physical dynamics of droplet rebound and retraction.

A polymer with sufficient molecular weight conserved in its linear chain length fashion and containing repeating monomer unit, each of which has sufficient hydrophobic moiety and sufficient hydrophilic moiety to facilitate a functional interaction with both polar and non-polar media and/or vehicle that may be used as a film-forming spreading agent.

The high molecular weight water soluble hydroxypolymer compound is a long chain polymer containing a hydroxy group. In one embodiment, the high molecular weight water soluble hydroxypolymer contains at least one hydroxy group per repeating unit of the polymer. Examples of the hydroxypolymer compounds include high molecular weight polyvinyl alcohols, crosslinked high molecular weight polyvinyl alcohols, and high molecular weight water soluble celluloses. In one embodiment, the high molecular weight water soluble celluloses are organo-chemically modified celluloses that are in powder form.

The high molecular weight water soluble hydroxypolymer compounds function to mitigate droplet rebound and promote physiochemically attachment of the droplet to the target surface as it spreads upon impact on the target surface. For example, the lipophilic side groups on the hydroxypolymer compounds interact with a lipophilic target surface and physiochemically attach the film droplet as it spreads upon impact preventing droplet rebound and achieving substantially uniform spreading on the hydrophobic or lipophilic target surfaces. Although not wishing to be bound by theory, this is believed to be partly or largely due to the inherent increase in viscosity obtained from using these polymer materials, thus over-spreading is minimized on hydrophilic substrates. Conversely, on hydrophobic substrates, it is believed that the lipophilic moiety of the long chain polymer interacts with the lipophilic substrate and prevents droplet retraction. The presence of at least one high molecular weight water soluble hydroxypolymer compound in a specified amount promotes uniform and idealized spreading over a variety of target surfaces, independent of the chemical composition of the agricultural particulate material mixture.

Lipophilic side groups lead to an increase in solubility in organic solvents, for example isopropanol or octanol. Generally speaking, lipophilic side groups are hydrocarbyl groups containing from about 1 to about 60 carbon atoms. In another embodiment, the lipophilic side groups are hydrocarbyl groups containing from about 2 to about 30 carbon atoms.

The term hydrocarbyl includes hydrocarbon as well as substantially hydrocarbon groups. Substantially hydrocarbon describes groups that contain heteroatom substituents or heteroatoms that do not alter the predominantly organic character of the lipophilic side group. Examples of hydrocarbyl groups include the following:

(1) hydrocarbon substituents, i.e., aliphatic (e.g., alkyl or alkenyl), alicyclic (e.g., cycloalkyl, cycloalkenyl) substituents, acyl, allyl, phenyl, aromatic-, aliphatic- and alicyclic-substituted aromatic substituents and the like as well as cyclic substituents wherein the ring is completed through another portion of the molecule (that is, for example, any two indicated substituents may together form an alicyclic radical);

(2) substituted hydrocarbon substituents, i.e., those substituents containing non-hydrocarbon groups which, in the context of this invention, do not alter the predominantly organic nature of the substituent(s); those skilled in the art will be aware of such groups (e.g., halo (especially chloro and fluoro, such as perfluoroalkyl, perfluoroaryl), cyanio, thiocyanato, amino, alkylamino, sulfonyl, hydroxy, mercapto, nitro, nitroso, sulfoxy, etc.); and

(3) heteroatom substituents, i.e., substituents which, while having a predominantly organic character within the context of this invention, contain an atom other than carbon present in a ring or chain otherwise composed of carbon atoms (e.g., alkoxy, alkylthio, hydroxylalkyl, esters, ethers, fatty acids, and the like). Suitable heteroatoms will be apparent to those of ordinary skill in the art and include, for example, sulfur, oxygen, nitrogen, fluorine, chlorine, and such substituents as, for example, pyridyl, furyl, thienyl, imidazolyl imido, amido, carbamoyl, etc.

Lipophilic side groups may be introduced using known synthetic organic chemistry methods, for example by acylation, for instance the reaction of acid chlorides, acid anhydrides and esters with primary and secondary amines. The number of lipophilic side groups that have to be introduced depends upon the degree of lipophilicity desired in the hydroxypolymer compounds. The hydroxypolymer compounds contain at least one lipophilic side group, and preferably more than one lipophilic side group. In one embodiment, the hydroxypolymer compounds contain at least one lipophilic side group for every 10 polymer repeating units. In another embodiment, the hydroxypolymer compounds contain at least one lipophilic side group for every 5 polymer repeating units. In yet another embodiment, the hydroxypolymer compounds contain at least one lipophilic side group for every 2 polymer repeating units. In still yet another embodiment, the hydroxypolymer compounds contain at least one lipophilic side group for every polymer repeating unit.

While not wishing to be bound by any theory, it is believed that the long chain hydroxypolymer containing a hydroxy group absorbs droplet impact energy and the lipophilic side groups on the hydroxypolymer compounds interact with the lipophilic target surface to physiochemically attach the droplet as it spreads upon impact to prevent droplet rebound and achieve droplet retention and uniform film-forming spreading on hydrophobic surfaces. In this connection, since impact energy is absorbed, the particulate material mixture is less likely to bounce off, blow off, shatter on impact or retract into spots on a substrate surface so that a uniform film can be achieved.

Polyvinyl compounds of this invention are water-soluble hydroxypolymers. One or more of non-hydrolyzed, partially hydrolyzed, substantially hydrolyzed, and fully hydrolyzed polyvinyl alcohols are employed in the present invention. Polyvinyl compounds are typically in powder, spherical, or granular form. In this connection, the particulate material and polyvinyl alcohols are mixed to achieve a substantially uniform mixture (uniform distribution of materials). In the present invention, high molecular weight polyvinyl alcohols are employed. Partially hydrolyzed polyvinyl compounds are preferred Low molecular weight polyvinyl compounds as used in the prior art are not employed since sufficient spreading is not achieved on hydrophobic surfaces with any known commercial variant. It is believed that spreading is not achieved with the prior art low molecular weight polyvinyl compounds because the polymer length is insufficient to prevent droplet retraction that results in spotty depositions. These low molecular weight polyvinyl alcohol compounds can be made to become functional by cross-linking to increase their molecular weight and increasing their lipophilicity with the use of a suitable cross-linking agent.

In one embodiment, high molecular weight polyvinyl alcohols have an average molecular weight of at least about 85,000 Daltons, and typically about 85,000 Daltons to about 250,000 Daltons. In another embodiment, high molecular weight polyvinyl alcohols have an average molecular weight of at least about 100,000 Daltons, and typically about 100,000 Daltons to about 225,000 Daltons. In yet another embodiment, high molecular weight polyvinyl alcohols have an average molecular weight of at least about 120,000 Daltons, and typically about 120,000 Daltons to about 200,000 Daltons. In still yet another embodiment, high molecular weight polyvinyl alcohols have an average molecular weight of at least about 140,000 Daltons, and typically about 140,000 Daltons to about 190,000 Daltons.

Polyvinyl alcohols are commercially available, or they can be made by polymerizing a vinyl acetate monomer. Examples of polyvinyl alcohols include those under the trade designation Celvol™, such as 203, 203S, 205, 205S, 523, 523S, 540, 540S, 805, 823, 840, SM-73, and HA-70, and the like, available from Celanese AG; those under the trade designation Elvanol®, such as 50-42, 51-05, 52-22, 70-06, 71-30, 75-15, 85-30, 85-82, 90-50, T-25, T-25LR, T-66, and T-91 available from DuPont; those under the trade designation Poval available from Kuraray Co. Ltd. of Japan; those under the trade designation Gohsenol, such as various N types, A types, G types, and K types available from Nippon Synthetic Chemical Industry Co. Ltd. of Japan; those available from Acetex/Erkol; and those available from Chang Chun Plastics of Taiwan.

The polyvinyl alcohols may be optionally cross-linked. For example, the polyvinyl alcohols may be cross-linked with cross-linking agents such as borax, glyoxal, ureaformaldehyde, Bacote-200®, Polycup 1720®, Baycoate® and the like to increase the molecular weight which further improves the deposition to the target surface. Compounds of increased molecular weight tend to absorb increased amounts of droplet impact energy. Analogously, compounds may contain increasing lipophilicity by decreasing the number of hydroxyl side groups per repeating unit of the polymer by cross-linking the linear polymer(s).

Modified high molecular weight celluloses of this invention are high molecular weight complex carbohydrates (polysaccharides) with thousands of glucose units in a generally linear chain structure that contain functional lipophilic side group substitutions. One or more of non-hydroxylated, partially hydroxylated, substantially hydroxylated, and fully hydroxylated celluloses are employed in the present invention. Less hydroxylation increases lipophilicity and improves spreading. Also, modification by varying degree of substitution of organophilic moieties such as methyl, ethyl, and propyl functional side groups to the hydroxypolymer chain produces greater lipophilicity to improve spreading of the particulate material mixture over hydrophobic surfaces. Celluloses are generally water-soluble polymers.

High molecular weight celluloses are defined as having an average measured viscosity for a 2% solution of at least about 1.0 millipascals/second@ 20° C. (m.Pas/sec), and typically about 8.0 m.Pas/sec or more and about 80.0 m.Pas/sec or less which corresponds to estimated molecular weight of 8,000-50,000 Daltons. In another embodiment, high molecular weight celluloses have an average measured viscosity for a 2% solution of at least about 10.0 m.Pas/sec, and typically about 10.0 m.Pas/sec or more and about 58.0 m.Pas/sec or less. In yet another embodiment, high molecular weight celluloses have an average measured viscosity for a 2% solution of at least about 60.0 m.Pas/sec, and typically about 58.0 m.Pas/sec or more and about 70.0 m.Pas/sec or less which corresponds to estimated molecular weight of 500,000-1,000,000 Daltons.

Examples of specific celluloses include ethyl hydroxyl ethyl cellulose, hydroxy ethyl cellulose, hydroxy propyl cellulose, hydroxy ethyl methyl cellulose, hydroxy propyl methyl cellulose, methyl cellulose, ethyl cellulose, ethyl methyl cellulose, cross-linked sodium carboxymethyl cellulose, enzymically hydrolyzed carboxymethylcellulose, and the like. Celluloses are commercially available from a number of sources including Methocel® by Dow Chemical and Culminal® by Hercules (Aqualon Division). Typically, ionic celluloses such as carboxy methyl cellulose are not found to work because they have an insufficient degree of lipophilic side groupings. However, the present inventors believe that ionic celluloses could be made functional by increasing the degree of lipophilic side groupings or by reducing the ionic potential of the polymer by such means as using a divalent cation such as calcium (Ca2+) to precipitate or desolubilize and deionize the ionic hydroxypolymer. All other long chain polymers are considered functional if they contain the correct orientation and number of lipophilic moiety side groups.

The modified high molecular weight complex carbohydrates may also be optionally cross-linked. For example, the modified high molecular weight complex carbohydrates may be cross-linked with borax, glyoxal, ureaformaldehyde, Bacote-200®, Polycup 172® and the like to increase the molecular weight which further improves the deposition to the target surface. Compounds of increased molecular weight tend to absorb increased amounts of droplet impact energy. Compounds may contain increasing hydrophilicity by increasing the number of hydroxyl side groups per repeating unit of the polymer.

In one embodiment, the particulate material mixture contains about 0.1% by weight to about 30% by weight of the spreading agent (dry weight). In another embodiment, the particulate material mixture contains at least about 0.4% to about 25% by weight of spreading agent (dry weight). In yet another embodiment, the particulate material mixture contains at least about 0.75% by weight to about 15% by weight of spreading agent (dry weight).

The presence of the high molecular weight hydroxypolymer compound in the specified amount contributes to the ability to achieve uniform and idealized spreading over substrates, regardless of the identity of the base particulate material or target surface identity. In this connection, the high molecular weight hydroxypolymer compound in the specified amount ensures advantageous spreading for all of the particulate materials mentioned herein. This is believed due to the inherent increase in viscosity obtained from using these materials, which prevents over-spreading on hydrophilic substrates. Conversely, on hydrophobic substrates, it is believed that the lipophilic moiety of the long chain polymer interacts with the lipophilic substrate and prevents droplet retraction. The high molecular weight hydroxypolymer compound in the specified amount also ensures advantageous film-forming spreading over all of the substrates mentioned herein.

Certain film-forming spreading agents also can volumize films. The benefits of volumized films are detailed below in the volumization section.

Notable substances that offer the advantageous trait of volumization are certain high molecular weight celluloses having sufficient lipophilicity or hydrophobicity and sufficient polymer chain length. An advantage of this trait is that a single substance can perform two normally separate and independent valuable functions, i.e., film-forming spreading and volumization. In most cases, the total amount of a single substance that both spreads and volumizes is less than the combined amount of separate spreading and volumization agents. One preferred example of a spreading agent that also volumizes is methylhydroxypropylcellulose (MHPC or HPMC).

Certain film-forming spreading agents, particularly polyvinyl alcohol PVOH, have the ability to work synergistically with volumization agents that in themselves do not have the ability to spread effectively on hydrophobic surfaces. One preferred example of such a combination is PVOH with animal glue.

The use of conventional surfactants, i.e. emulsifiers, detergents, formulated spreaders etc., can detrimentally interact with the present film-forming spreading agents to hinder functionality.

Certain commonly used additives may act as a spreading inhibitor. The phrase “spreading inhibitor” as used herein means a substance that has both low spreading on hydrophobic surfaces and may prevent other known spreaders from spreading. Examples of spreading inhibitors include low molecular weight hydroxyl ethyl cellulose (HEC) and carboxymethyl cellulose (CMC).

We have discovered that in the absence of a spreading inhibitor, a composition comprising at least one particle and equal to or greater than 0.30% by weight of spreading agent unexpectedly provides a film forming composition. If a spreading inhibitor is present, the present composition comprises at least one particle and greater than 0.35% by weight of film-forming spreading agent.

Stickers:

Certain film-forming spreading agents and volumization agents as described above also act as effective stickers as defined above.

Particles:

Particles used in the dry mixture and the slurries are hydrophobic or hydrophilic. Particles may be hydrophobic in and of themselves; an example is talc. Alternatively, the particles may be hydrophilic materials that are rendered hydrophobic by application of a surface treatment; for example, the particle has a hydrophilic core and a hydrophobic outer surface. In another embodiment, the particles are hydrophilic in and of themselves; an example is calcined kaolin. In yet another embodiment, the particles are hydrophobic in and of themselves and made hydrophilic by the addition of wetting agents such as surfactants or emulsifiers.

Examples of preferred mineral particles include crude kaolin; hydrous kaolin; water processed kaolin; air processed kaolin; calcined kaolin; natural calcium carbonate; anhydrite; sillimanite group minerals such as andalusites, kyanites, sillimanites; staurolite, tripoli; tremolite; natural gypsum; anhydrite; asbestos materials; adobe materials; barites; bauxite; pumices, volcanic cinders, slags, scorias, expanded shales, volcanic cinders, carbonates such as limestones and dolomites; diamond dusts both synthetic and natural; emerys; micas such as biotites and muscovites; garnets; gilsonites; glauconites; vermiculites, fly ashes, ash waste, grogs (broken or crushed brick), shells (oyster, coquina, etc.); wash plant or mill tailings, phosphate rocks; potash; nepheline syenites, beryllium materials such as beryls; borons and borates, talcs, clay minerals such as fullers earths, bentonite, ball clays, halloysites, refractory clays, flint clays, shales, fire clays, ceramic clays, coal containing kaolins, smectites (montmorillonite, saponites, hectorites, etc); hormites (attapulgites, pyrophyllites, sepeolites, etc.); silica; sand; quartz; olivines; feldspars; chalks; diatomaceous earths and barytes; insulation materials such as calcium silicates, glass fibers, mineral wools or rock wools; wollastonites; graphites; refractory materials; vermiculites; perlites; rare earth minerals; elemental sulfurs and other sulfur minerals; other insoluble elemental and salt compounds; other miscellaneous insoluble particles; other functional fillers such as, pyrogenic silicas, titanium minerals such as titanium dioxides, magnesium oxides, coal dust, magnesite, natural zeolite, and microspheres (spherical agglomerations of calcined kaolin particles generally larger than 10 microns in diameter), aluminum trihydrate, hollow mineral-based spheres, chemical or physically activated forms of any of the preceding, and acid-activated bentonite.

Examples of useful non-mineral particles include hemps, cellulose pulp, wood pulp, micronized plastics, waxes and other micro and macro organic and inorganic particles.

Useful synthetic particles include precipitated calcium carbonates, micronized plastics, essentially non-crystalline silicas such as precipitated silica and fumed silica, hollow mineral-based and plastic spheres, synthetic aluminum trihydrate, synthetic zeolite, laponite, aluminum trihydrate, and synthetic gypsum.

Examples of non-mineral hydrophilic particles include carbon soot, coal dust, ash waste, and other colored organic materials. A preferred base particle is water processed mineral. Examples of useful water processed kaolin are commercially available from Engelhard Corporation as HT®, LUSTRA®, ULTRACOTE™ kaolin, ULTRA-WHITE®, ULTRA-GLOSS™, ASP®170, ASP101, GORDON70, ASP400, ASP900, NUCLAY® kaolins, and attapulgites such as ATTAGEL® 50, 40, 36, and 20 and MICROSORB® 100, 200, and 300 RVM or LVM (which are not water processed), available from BASF Catalysts LLC (formerly Engelhard Corporation). The particles suitable for use in the present invention are finely divided. The term “finely divided” when utilized herein means that the particles have a median individual particle size (average diameter) below about 100 microns. Preferably, the particles have a median individual particle size of equal to or less than about 10 microns or less. Other embodiments follow:

Median Particle Size
equal to or less than about three microns
equal to or less than about one micron
equal to or less than about 0.6 micron
equal to or less than about 0.4 micron
equal to or less than about 0.3 micron

Examples of heat treated particles are materials that have been heated to an elevated temperature and include baked, calcined, and fired materials. Heat treated particles are generally hydrophilic. Specific examples include metakaolin, calcined calcium carbonate, calcined talc, calcined kaolin, baked kaolin, fired kaolin, hydrophobic treated heat treated kaolin, calcined bentonites, calcined attapulgite, calcined clay, calcined pyrophyllite, calcined silica, calcined feldspar, calcined sand, calcined quartz, calcined chalk, calcined limestone, calcined precipitated calcium carbonate, baked calcium carbonate, calcined diatomaceous earth, calcined barytes, calcined aluminum trihydrate, calcined pyrogenic silica, and calcined titanium dioxide. Calcined kaolins useful in the present invention are commercially available from Engelhard Corporation.

Heat treatment in accordance with the invention commonly involves heating a particle at a temperature from about 100° C. to about 1200° C. for about 1 second to about 24 hours. In another embodiment, heat treatment involves heating a particle at a temperature from about 400° C. to about 1,100° C. for about 1 minute to about 15 hours. In yet another embodiment, heat treatment involves heating a particle at a temperature from about 500° C. to about 1000° C. for about 10 minutes to about 10 hours. The heat treatment may be carried out in air, in an inert atmosphere, or under a vacuum.

In another embodiment, heat treatment involves heating a particulate material at a temperature from about 400° C. to about 1,200° C. for about 10 seconds to about 24 hours. In yet another embodiment, heat treatment involves heating a particulate material at a temperature from about 500° C. to about 1,000° C. for about 10 minutes to about 10 hours. The heat treatment may be carried out in air, in an inert atmosphere or under a vacuum.

In these embodiments, the particles contain at least about 25% by weight, and particularly about 25% to about 100% by weight of heat treated particles. In another embodiment, the particles contain at least about 40% by weight, and particularly about 40% to about 99% by weight of heat treated particles.

The surfaces of the particles materials may be made hydrophobic by coating the particle with at least one hydrophobic agent. Industrial mineral application, especially in organic systems such as plastic composites, films, organic coatings or rubbers, utilize hydrophobic surface treatments to render a mineral surface hydrophobic; see, for example, Jesse Edenbaum, Plastics Additives and Modifiers Handbook, Van Nostrand Reinhold, New York, 1992, pages 497-500 which is incorporated herein by reference for teachings of such hydrophobic treatment materials and their application. These surface treatment materials include coupling agents such as fatty acids and silanes are commonly used to surface treat solid particles to render them hydrophobic. Examples of hydrophilic materials that are made hydrophobic include organic titanates such as Tilcom® from Tioxide Chemicals; organic zirconate or aluminate coupling agents from Kenrich Petrochemical, Inc.; organofunctional silanes such as vinyltriethoxysilane; vinyl tris-(2-methoxyethoxy)silane; γ-methacryloxypropyltri methoxysi lane; β-3,4, epoxycyclohexyl)ethyltrimethoxysilane; γ-glycidoxypropyltrimethoxysilane; γ-mercaptopropyltrimethoxysilane; γ-aminopropyltriethoxysilane; N-β-(aminoethyl)-γ-(aminopropyltrimethoysilane, and β-mercaptoethyltriethoxysilane, and others under the trade designation Silquest® from Witco or those under the trade designation Prosil® from PCR; modified silicone fluids such as the DM-Fluids obtained from Shin Etsu; and fatty acids such as double pressed stearic acid and triple pressed stearic acid and others under the trade designation Hystrene® or Industrene® from Witco Corporation or those under the trade designation Emersol® from Henkel Corporation. In a specific embodiment, stearic acid and stearate salts are particularly effective for rendering a particle surface hydrophobic.

The surfaces of the hydrophobic particles can be made hydrophilic by coating the particulate material with at least one hydrophilic agent. Examples of these types of hydrophobic particles that can be made hydrophilic include, but are not limited to, minerals such as talc, micronized plastics such as polyethylene powders, carbon materials such as carbon black, lamp black, and the like. These hydrophobic materials may be made hydrophilic by the addition of a wetting agent. Wetting agents include cationic, anionic, and nonionic surfactants.

Further specific examples of particles suitable for this invention include metakaolins sold under the trade designation METAMAX®, calcined kaolins under the trade designation SATINTONE® kaolin clay, and siloxane treated calcined kaolins under the trade designation TRANSLINK® clay from Engelhard Corporation, Iselin, N.J.; calcium carbonate under trade designations ATOMITE® and SUPERMITE®, from Imerys and stearic acid treated ground calcium carbonates under the trade designations SUPERCOAT® and KOTAMITE® from Imerys.

The particles best suited for use in the present invention are finely divided. The term “finely divided” when utilized herein means the particles have a median individual particle size (average diameter) below about 100 μm. In one embodiment, the particles have a median individual particle size of about 10 μm or less. In another embodiment, the particles have a median individual particle size of about 3 μm or less. In yet another embodiment, the particles have a median individual particle size of about 1 μm or less.

Particle size and particle distribution as used herein are measured with a Micromeritics Sedigraph 5100 Particle Analyzer. Measurements are recorded in deionized water for hydrophilic particles. Dispersions are prepared by weighing 4 grams of dry sample into a plastic beaker, adding dispersant and diluting to the 80 ml mark with deionized water. The slurries are then stirred and set in an ultrasonic bath for 290 seconds. Typically, for kaolin, 0.5% tetrasodium pyrophosphate is used as a dispersant; with calcium carbonate, 1.0% Calgon T is used. Typical densities for the various powders are programmed into the sedigraph, for example, 2.58 g/ml for kaolin. The sample cells are filled with the sample slurries and the X-rays are recorded and converted to particle size distribution curves by the Stokes equation. The median particle size is determined at the 50% level.

The present invention uses a particle mixture that contains about 70% by weight or more and about 99.9% by weight or less of one or more of at least one particle (dry weight). In another embodiment, the particle mixture contains about 75% by weight or more and about 98% by weight or more of one or more of at least one particle (dry weight).

Volumization Agents:

Volumization agents have been shown to work advantageously in combination with film-forming spreading agents.

The volumized particle film results in a higher level of efficiency per number of particles per a given mass of film. Due to the volumized and/or flocked or otherwise associated structure, several advantages are obtainable. The volumized particle film has highly separated particles. The volumized film exhibits improved elastic properties, flexural properties, and energy buffering properties making it less vulnerable to cracking, chipping, an/or flaking, thereby improving weatherability by reducing wash-off and wind attrition while improving adhesion. The volumized particle film is less likely than a conventional spread film to have its particles deeply embedded in the waxy cuticle of fruit. When employing particles on plants, the volumized particle film improves scattering of undesirable infrared and ultraviolet light. Also, because more uniform depositions are produced, more uniform light is transmitted to the substrate resulting in more uniform color and less mottling. The volumized particle film has improved insect control compared to a conventional spread film due to its increased friability, greater surface area and greater number and mass of particles available to contact the pest.

As noted in the film-forming spreading agent section above, there are film-forming spreading agents that have the ability to both spread and volumize. Other volumization agents can be employed in combination with the film-forming spreading agents described above in a previously-described synergistic manner. Thus, in another embodiment, the particle mixture optionally contains one or more volumization agents, such as animal glue, water-soluble polymers including polyacrylamide (PAM), polyamines (epichlorohydrin-dimethylamine); or polyacrylate materials, polydiallyldimethylammonium chloride (polyDADMAC) and epichlorohydrin-dimethylamine (Epi-DMA). Polyacrylates have the repeating unit —[CH₂—CR(CO₂R)]ₙ— wherein each R is independently a hydrogen, or alkoxy or alkyl group containing 1 to about 4 carbon atoms, and n is from about 250 to about 10,000. In another embodiment, each R is independently a hydrogen or methyl group and n is from about 500 to about 5,000 Daltons. The phrase “high molecular weight”, used in connection with high molecular weight polyacrylates, and high molecular weight polyacrylamides, means having an average molecular weight of at least about 25,000 Daltons, and typically about 25,000 to about 1,500,000 Daltons. In another embodiment, high molecular weight means having an average molecular weight of at least about 50,000 Daltons, and typically about 50,000 to about 1,000,000 Daltons. In yet another embodiment, high molecular weight means having an average molecular weight of at least about 75,000, and typically at least about 75,000 Daltons to about 500,000 Daltons. Examples include polymethylacrylate, polyethylacrylate, polyacrylic acid, polymethylmethacrylate, polyethylmethacrylate, poly (2-hydroxyethyl methacrylate), and the like. High molecular weight polyacrylamides are commercially available from a number of sources including SNF Floerger of France and Jinke Chem of China.

In one embodiment where the particle mixture contains both high molecular weight hydroxypolymer compound and polyacrylates, the amount of high molecular weight hydroxypolymer compound required can be decreased. In one embodiment, the particulate material mixture contains at least about 0.1% by weight to about 30% by weight of one or more high molecular weight hydroxypolymer compound (dry weight). In another embodiment, the particle mixture contains at least about 0.36% by weight to about 20% by weight of one or more high molecular weight hydroxypolymer compound (dry weight). In yet another embodiment, the particle mixture contains at least about 1.25% by weight to about 10% by weight of one or more high molecular weight hydroxypolymer compound (dry weight).

In another embodiment, due to the particle mixture containing both high molecular weight hydroxypolymer compound and animal glue, the amount of high molecular weight hydroxypolymer compound required can be decreased. Although animal glue is considered to be hydrolyzed collagen, for purposes of this invention, animal glue materials include gelatin, collagen, and glue. Gelatin materials generally have an average molecular weight from about 20,000 Daltons to about 250,000 Daltons. While not wishing to be bound by any theory, it is believed that the animal glue materials facilitate the formation of particulate material agglomerates as well as facilitate binding between particulate material agglomerates and substrates.

Glue is a form of gelatin that is an adhesive consisting of organic colloids of a complex protein structure obtained from animal materials such as bones and hides in meat packing and tanning industries. Glue contains two groups of proteins; namely, chondrin and gluten. Animal glues suitable for this invention may be acquired from a number of sources including Milligan and Higgins, Extraco, U.S. Adhesives, National Starch & Chemical, and J. Hewit & Sons Ltd. Animal glue materials are typically in powder, spherical, or granular form. In one embodiment, due to the particulate material mixture containing high molecular weight hydroxypolymer material and animal glue, the amount of high molecular weight hydroxypolymer compound required can be decreased.

Accordingly, in one embodiment, the particle mixture contains at least about 0.1% by weight to about 5% by weight of film-forming spreading agent and at least about 0.1% by weight to about 5% by weight of animal glue material (dry weight). In another embodiment, the particulate material mixture contains at least about 0.4% by weight to about 4.5% by weight of film-forming spreading agent and at least about 0.4% by weight to about 4% by weight of animal glue material (dry weight). In yet another embodiment, the particulate material mixture contains at least about 0.6% by weight to about 4% by weight of film-forming spreading agent and at least about 0.5% by weight to about 3% by weight of animal glue material (dry weight). In embodiments where the particulate material mixture contains both high molecular weight hydroxypolymer compound and animal glue material, the weight ratio of high molecular weight hydroxypolymer compound to animal glue material is about 1:5 to about 10:1. In another embodiment, the weight ratio of high molecular weight hydroxypolymer compound to animal glue material is about 1:2 to about 5:1.

In another embodiment, due to the particle mixture containing both high molecular weight hydroxypolymer compound and gum, the amount of high molecular weight hydroxypolymer compound required may be decreased. The term gum is a generic name for a class of substances that are naturally derived materials occurring widely in plants and to a more limited extent in the animal kingdom. Gums are organic in nature, of indefinite composition (as they appear to be complexes associated with plant life processes) and are related to sugars and carbohydrates. Gum materials are water-loving colloids, which appear to dissolve, but in actuality disperse, swell, or absorb water. They will form viscous solutions or mucilages by either dissolving or by absorbing many times their own volume of water and are both hydrophilic and hydrophobic. Commercially the term embraces a group of substances whose properties form viscous adhesives, jellies or pastes (Mantell 1947). For purposes of this invention, gum materials include, but are not limited to the following: Tree derived exudation products such as Acacia tree gum and its varieties (Arabic gums, etc.); India derived gums (Ghatti gum, Karaya gum, etc.); gums from the Astragalus plant (Tragacanth gum, Persian gums, etc.); miscellaneous gums such as those derived from the Prunis tree, gums from North and South America (Angico gum, Balsa gum, etc.) Seaweed based extracts such as agar, Irish moss, Carrageenan gum, and algin and alginate materials; Hemicellulose materials such as seed extracts (Locust bean gum, Locust kernel gum, quince seed gum, guar gum, etc.), Iceland moss, Flaxseed, Psyllium seed, Quince seed, etc.; modified starches such as Dextrin and British gums; modified celluloses such as carboxymethyl cellulose, hydroxyethyl cellulose and those not functional as spreading agents as defined in this present invention. In addition, miscellaneous animal glue materials can also be defined as gums. While not wishing to be bound by any theory, it is believed that the gum materials facilitate the formation of particle agglomerates as well as facilitate binding between particle agglomerates and substrates. Gums suitable for this invention can be acquired from a number of sources including Hercules, Hercules-Aqualon division, Dow Chemical Company, AEP Colloids, Penford Food Ingredients Company, P.L. Thomas and Company, Inc., U.S. Adhesives, National Starch & Chemical, and J. Hewit & Sons Ltd. Gum materials are typically in powder, sphere, or granular form.

In one embodiment, due to the particle mixture containing both high molecular weight hydroxypolymer material and gum, the amount of high molecular weight hydroxypolymer compound required can be decreased. Accordingly, in one embodiment, the particle mixture contains about 0.1% by weight to about 5% by weight of at least one high molecular weight hydroxypolymer compound and about 0.1% by weight to about 5% by weight of gum material (dry weight). In another embodiment, the particle mixture contains about 0.4% by weight to about 4.5% by weight of at least one high molecular weight hydroxypolymer compound and about 0.4% by weight to about 4% by weight of gum material (dry weight). In yet another embodiment, the particle mixture contains about 0.6% by weight to about 4% by weight of at least one high molecular weight hydroxypolymer compound and about 0.5% by weight to about 3% by weight of gum material (dry weight). In embodiments where the particle mixture contains both high molecular weight hydroxypolymer compound and gum material, the weight ratio of high molecular weight hydroxypolymer compound to animal glue material is about 1:5 to about 10:1. In another embodiment, the weight ratio of high molecular weight hydroxypolymer compound to gum material is about 1:2 to about 5:1.

Foaming agents may be used as volumization agents as the gas entrained in the application has the capability to create extremely volumized and friable systems. Some examples of foaming agents are detergents, proteinaceous substances, and water soluble polymers (higher molecular weighs preferred). By nature, the spreading agents disclosed above are effective foaming agents.

Examples of useful minerals include magnesium aluminum silicates and colloidal clays include attapulgites and bentonites. Attapulgites and bentonites may be beneficiated or otherwise processed. Useful attapulgite is commercially available from Engelhard Corporation (now BASF Catalysts LLC).

Active Inciredients and Additives:

The film-forming spreading agent may improve or enhance the performance of an active ingredient or additive and thus, act as an agricultural adjuvant, co-adjuvant or formulating aid.

Useful active ingredients or additives include pest control agent such as pesticide, fungicide, insecticide, acaracide, molluscicide, suspending agent, thickening agent, nutrient, microbial agent, fertilizer, herbicide, growth regulator, plant hormone and the like that are used in agricultural or other industry practices involving film forming agents.

In one embodiment, the mixture contains about 0.01% by weight to about 10% by weight of at least one active ingredient (dry weight). In another embodiment, the particle mixture contains about 0.1% by weight to about 5% by weight of at least one active ingredient (dry weight).

In one embodiment, the application of the mixture may be applied to the target surface as a slurry of particles in a volatile liquid such as water, a low boiling organic solvent or low boiling organic solvent/water mixtures.

In yet another embodiment, the mixture can be applied to the target surface as a paste, cream or foam based on low or high organic solvent/water mixtures. One or more layers of this slurry, cream or foam can be sprinkled, sprayed, foamed, brushed on or otherwise applied to the target surface. The resultant residue, whether formed by a slurry application, may be hydrophilic or hydrophobic.

In another embodiment where the slurry contains water, the particulate material mixture, and optionally further additives, the further additives include low boiling organic liquid; high boiling organic liquid; emulsifying agent; suspending agent; penetrating agent; wetting agent; thickening agent; stabilizer; nutrient; microbial agent; fertilizer; and herbicide. The slurry may be formed by combining the components in any order, followed by mixing.

The low boiling organic liquids include water-miscible and organic solvents. In one embodiment, the low boiling organic liquids contain from 1 to about 6 carbon atoms. The term low boiling as used herein means organic liquids that have a boiling point generally no higher than about 100° C. These liquids promote the ability of the particulate material mixture to remain in a finely divided state without significant agglomeration. Examples of low boiling organic liquids include alcohols such as methanol, ethanol, propanol, i-propanol, butanol, i-butanol, and the like, glycols (polyols), ketones such as acetone, methyl ethyl ketone and the like, and cyclic ethers such as ethylene oxide, propylene oxide and tetrahydrofuran. Combinations of the above-mentioned low boiling organic liquids, with or without water, can also be employed.

The particles can be incorporated into dry mixtures such as wettable powders or wet mixtures such as liquids, emulsions, slurries, creams, foams or pastes. The mixtures can be applied as sprays, dips, brushed, rubbed or otherwise topically applied to a target surface. The particles used can be either hydrophobic or hydrophilic. In one embodiment, the particles are hydrophobic in and of themselves, (for example, mineral talc). In another embodiment, the particles are hydrophilic materials that are rendered hydrophobic by application of an outer coating of a suitable hydrophobic wetting agent or coupling agent (for example, in an embodiment where a particle has a hydrophilic core and a hydrophobic outer surface). In yet another embodiment, the particles are hydrophilic in and of themselves (calcined kaolins).

When high molecular weight polymeric film forming material, water-insoluble cross-linkable polymeric film forming material, and/or cross-linking agents in the powder form are used, the powder has a median individual particle size (average diameter) below about 500 μm. In another embodiment, the powder has a median individual particle size below about 350 μm. In yet another embodiment, the powder has a median individual particle size below and about 200 μm.

When high molecular weight polymeric film forming material, water-insoluble cross-linkable polymeric film forming material, and/or cross-linking agent in the powder form are used, a premix containing the particles and one or more of the high molecular weight polymeric film forming material, water-insoluble cross-linkable polymeric film forming material, and/or cross-linking may be provided. In one embodiment, the premix contains about 1% by weight or more and about 40% by weight or less of one or more of high molecular weight polymeric film forming material, water-insoluble cross-linkable polymeric film forming material, and/or cross-linking agent and about 60% by weight or more and about 99% by weight or less of the particles (all %'s dry weight). In another embodiment, the premix contains about 2% by weight or more and about 30% by weight or less of one or more of high molecular weight polymeric film forming material, water-insoluble cross-linkable polymeric film forming material, and/or cross-linking agent and about 70% by weight or more and about 98% by weight or less of the particles.

In one embodiment, the application of the particulate mixture can be applied to the target surface as a slurry of particles in a volatile liquid such as water, a low boiling organic solvent or low boiling organic solvent/water mixtures. In yet another embodiment, the particulate mixture can be applied to the target surface as a paste, cream or foam based on low or high organic solvent/water mixtures. One or more layers of this dust, slurry, cream or foam can be dusted, sprinkled, sprayed, foamed, brushed on or otherwise applied to the target surface. The resultant residue, whether formed by a dust or slurry application, may be hydrophilic or hydrophobic.

In another embodiment where the slurry contains water, the particle mixture, and optionally further additives, the further additives include low boiling organic liquids, high boiling organic liquids, pest control agents such as pesticides, fungicides, insecticides, etc., an emulsifying agent, a suspending agent, a penetrating agent, a wetting agent, a thickening agent, a stabilizer, nutrients, microbial agents, fertilizers, herbicides, etc. The slurry may be formed by combining the components in any order, followed by mixing.

Low boiling organic liquids may be employed to facilitate applying the particulate material mixture by spraying to target surfaces. Typically, the low boiling organic liquids are used in an amount sufficient to facilitate the formation of a dispersion of the particulate material mixture. In one embodiment, the amount of low boiling organic liquid is up to about 30% (volume percent) of the dispersion. In another embodiment, the amount of low boiling organic liquid is from about 1% to about 20% (volume percent) of the dispersion. In yet another embodiment, the amount of low boiling organic liquid is from about 2% to about 10% (volume percent) of the dispersion. The particulate material mixture is preferably added to a low boiling organic liquid to form a slurry and then this slurry is diluted with water to form an aqueous dispersion.

In one embodiment, the particle material mixture is applied as a slurry that contains the low boiling point organic liquids can contain about 30% by weight to about 99.9% by weight of water and about 0.1% by weight to about 60% by weight of the particulate material mixture. In another embodiment, the slurry contains about 50% by weight to about 99.75% by weight of water (which may include the low boiling organic liquids) and about 0.25% by weight to about 50% by weight of the particulate material mixture. In yet another embodiment, the slurry contains about 60% by weight to about 99.5% by weight of water (which may include the low boiling organic liquids) and about 0.5% by weight to about 40% by weight of the particulate material mixture.

Utility

The current invention allows for the improved delivery of a desired contact angle that may be approximately 90 degrees to a wide variety of target substrates and is generally less dependent on the contact angle of the target substrate.

The target surfaces to which the present invention is applied can be porous and non-porous, homogeneous and heterogeneous, solid, liquid or gaseous, hydrophobic and hydrophilic surfaces that are smooth or rough, and can be purified, oxidized, contaminated or otherwise modified. Examples of target surfaces include but are not limited to plant and animal surfaces, or surfaces of man-made structures, or other natural and man-made surfaces. Agricultural substrates include plant substrates or surfaces and animal substrates or surfaces. Plant surfaces include those found on crops, household and ornamental plants, greenhouses, forests with types of surfaces that include leaves, stems, roots, trunks, or fruits, and include soil or other growth mediums, and the like. Examples of animal surfaces include those found on man, birds, arthropods, mollusks, cattle, sheep, horses, chickens, dogs, cats, fish and the like with types of surfaces that include skin, hair, fur, feathers and the like. Examples of man-made structures include, but is not limited to, those found on walls, floors, shelves, ceilings, stairs and the like in buildings, barns, pens, cages, animal bedding, building foundations, greenhouses, electrical boxes and the like. Examples of man-made surfaces include metal, alloys, paper, ceramics, glass, concrete, plastic, polystyrene, asphalt, lumber, and the like. Examples of natural surfaces include hides, soil, stone, sand, crude oils, tars, water, ice, wood, lumber, and the like. All of such surfaces shall be collectively referred to as target surfaces.

The horticultural crops to which this invention relate can include actively growing and fruiting agricultural and ornamental crops and the products thereof, including those selected from the group consisting of fruits, vegetables, trees, flowers, grasses, roots, seeds and landscape and ornamental plants. Particle films can also be applied to harvested crops, dormant crops, plants to reduce bark insect infestation, sunburn and cracking, for example, and on the ground under or near plants to improve reflection of useful light onto the plants. Particle films can be applied to animal surfaces for the purpose of protection from disease, parasites, insects, heat stress, and solar injury. One benefit of the present invention is faster drying times and this minimizes the opportunity for disease growth.

The uses of the present agricultural composition include but are limited to crop protectant, pest control and pesticide, disease control, growth regulator, delivery vehicle, protective tree paint, animal protectant, heat stress reducer, growth enhancer, agricultural aid, solar protection, sunburn reducer, frost/freeze preventing agent, nucleating agent, mineral wick, ground-applied light reflectant, remedy for certain physiological disorders (watercore, corking, and bitterpit), coating aid, heat stress reducer, weed control, and increasing resistance to freeze dehydration.

A premix or the slurry may contain an additive such as a pest control agent such as pesticides, fungicides, molluscicides, insecticides, acaracides, bactericides, herbicides, antibiotics, antimicrobials, nemacides, rodenticides, entomopathogens, pheromones, attractants, plant growth regulators, insect growth regulators, chemosterilants, microbial pest control agents, repellents, viruses, phagostimulents, plant nutrients, etc., an emulsifying agent, a suspending agent, a penetrating agent, a wetting agent, a thickening agent, a stabilizer, nutrients, microbial agents, fertilizers, herbicides, and the like. In one embodiment, the premix or slurry contains about 0.01% by weight or more and about 10% by weight or less of one or more additives. In another embodiment, the particle mixture contains about 0.1% by weight or more and about 5% by weight or less of one or more additives.

The slurry is applied to the target surfaces by spraying, or other suitable means. The particle treatment may be applied as one or more layers. The amount of material applied varies depending upon a number of factors, such as the identity of the substrate, the purpose of the application, and the identity of the particulate material, etc. In any given instance, the amount of material applied can be determined by one or ordinary skill in the art. The amount may be sufficient to form a continuous film, semi-continuous, or intermittent film over all or a portion of the substrate to which the particle treatment is applied.

The particle film treatment may form a continuous layer. By continuous, it is meant that, where applied, the resultant dry film is continuous (or substantially continuous). For example, in an embodiment where the upper third of a fruit is covered with particulate material mixture in accordance with the present invention, the particle film covering the upper third of the fruit is continuous or substantially continuous while the bottom two-thirds of the fruit is not covered with the particulate material mixture or forms a spotted or discontinuous film/deposition.

In the continuous particle film, the maximum average size (average diameter) of pores or non-continuous areas in the particle film is generally less than about 100 μm. In another embodiment, the maximum average size of openings or non-continuous areas in the particle film is generally less than about 10 μm. In yet another embodiment, the maximum average size of openings or non-continuous areas in the particle film is generally less than about 5 μm.

Typically, the thickness of the particle film applied using slurry ranges from about 1 μm to about 1,000 μpm. In another embodiment, the thickness of the particle film ranges from about 3 μm to about 300 μm. In another embodiment, the thickness of the particle film ranges from about 5 μm to about 750 μm.

In one embodiment, the particle films made in accordance with the present invention do not materially affect the exchange of gases on the target surface. The gases that pass through the particle treatment (or residue from the inventive treatment) are those that are typically exchanged through the target surface and the environment (for example: plant, soil or plant-producing surfaces, mammalian skin, fur or other surfaces). Such gases, vapors or scents include water vapor, carbon dioxide, oxygen, nitrogen, volatile organic compounds, volatile inorganic compounds, fumigants, pheromones and the like.

In another embodiment, the particles may form a gas impermeable film that restricts the exchange of gases on the surface of the substrate. In this embodiment, a gas impermeable film is formed that retards gas exchange and traps gases from passing through the film formed by the hydroxypolymer based films. The gases which do not pass through the particle treatment of this embodiment are those that are typically exchanged through the substrates and the environment (for example: plant, soil or plant-producing surfaces, mammalian skin, fur or other surfaces). Such gases, vapors or scents include water vapor, carbon dioxide, oxygen, nitrogen, volatile organic compounds, volatile inorganic compounds, pheromones, fumigants and the like.

The present agricultural compositions may be used to enhance photosynthesis as disclosed in U.S. Pat. No. 6,110,867, incorporated in its entirety herein by reference. Photosynthesis is the process by which photosynthetic plants utilize solar energy to build carbohydrates and other organic molecules from carbon dioxide and water. The conversion of carbon dioxide to such organic molecules is generally referred to as carbon fixation or photosynthesis and, in most plants, occurs by the reductive pentose phosphate cycle, generally referred to as the C-3 cycle. The study of the path of carbon in photosynthesis four decades ago (A.A. Benson (1951), “Identification of Ribulose in ¹⁴CO₂ Photosynthesis Products” J. Am. Chem. Soc. 73:2971; J. R. Quayle et al. (1954), “Enzymatic Carboxylation of Ribulose Diphosphate” J. Am. Chem. Soc. 76:3610) revealed the nature of the carbon dioxide fixation process in plants. Enhanced or improved photosynthesis is evidenced by increased carbon dioxide uptake or assimilation. Enhanced photosynthesis has many benefits including increased yields/productivity, e.g., increased fruit size or production (usually measured in weight/acre), improved color, increased soluble solids, e.g. sugar, acidity, etc., reduced plant temperature, increased storage life, increased turgor.

The present agricultural composition may be used in the particle film applications disclosed in U.S. Pat. Nos. 5,908,708; 6,027,740; 6,060,521; 6,069,112; 6,156,327; 6,235,683; 6,464,995; and 6,514,512, all incorporated in their entirety herein by reference.

Since gases such as carbon dioxide enter plants through the plants' stomates and the aperture of a stomate varies depending upon the plant, one skilled in the art having selected a horticultural crop and desiring a particle film that does not materially affect the exchange of gases on the horticultural crop would select a composition particle size and amount of application for that selected crop to achieve the desired result. The present agricultural composition may be applied from about 25 up to about 5,000 micrograms of particulate material per cm² of surface for particles having specific density of around 2-3 g/cm³, more typically from about 100 up to about 3,000, and preferably from about 100 up to about 500. In addition, environmental conditions such as wind and rain may reduce coverage of the particulate material and therefore, multiple applications may be desirable.

The present agricultural composition may be used in the particle film applications disclosed in U.S. Pat. Nos. 5,908,708; 6,027,740; 6,060,521; 6,069,112; 6,156,327; 6,235,683; 6,464,995; and 6,514,512, all incorporated in their entirety herein by reference. Since gases such as carbon dioxide enter plants through the plants' stomates and the aperture of a stomate varies depending upon the plant, one skilled in the art having selected a horticultural crop and desiring a particle film that does not materially affect the exchange of gases on the horticultural crop would select a composition particle size and amount of application for that selected crop to achieve the desired result.

The present agricultural composition may be used in the particle film applications disclosed in U.S. Pat. Nos. 5,908,708; 6,027,740; 6,060,521; 6,069,112; 6,156,327; 6,235,683; 6,464,995; and 6,514,512, all incorporated in their entirety herein by reference. Since gases such as carbon dioxide enter plants through the plants' stomates and the aperture of a stomate varies depending upon the plant, one skilled in the art having selected a horticultural crop and desiring a particle film that does not materially affect the exchange of gases on the horticultural crop would select a composition particle size and amount of application for that selected crop to achieve the desired result.

The present agricultural composition may be used in the particle film applications disclosed in U.S. Pat. Nos. 5,908,708; 6,027,740; 6,060,521; 6,069,112; 6,156,327; 6,235,683; 6,464,995; and 6,514,512, all incorporated in their entirety herein by reference.

Since gases such as carbon dioxide enter plants through the plants' stomates and the aperture of a stomate varies depending upon the plant, one skilled in the art having selected a horticultural crop and desiring a particle film that does not materially affect the exchange of gases on the horticultural crop would select a composition particle size and amount of application for that selected crop to achieve the desired result. The present agricultural composition may be applied from about 25 up to about 5,000 micrograms of particulate material per cm² of surface for particles having specific density of around 2-3 g/cm³, more typically from about 100 up to about 3,000, and preferably from about 100 up to about 500. In addition, environmental conditions such as wind and rain may reduce coverage of the particulate material and therefore, multiple applications may be desirable.

Non-agricultural uses for the present invention include as a masking spray for painting, temporary coating, acoustic interference and disruption, infrared radiation dissipation, and camouflaging military vehicles and equipment.

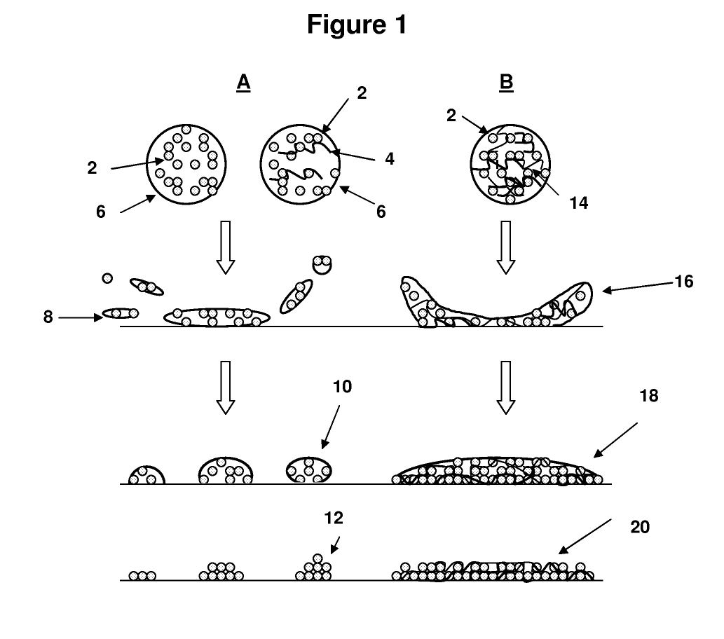

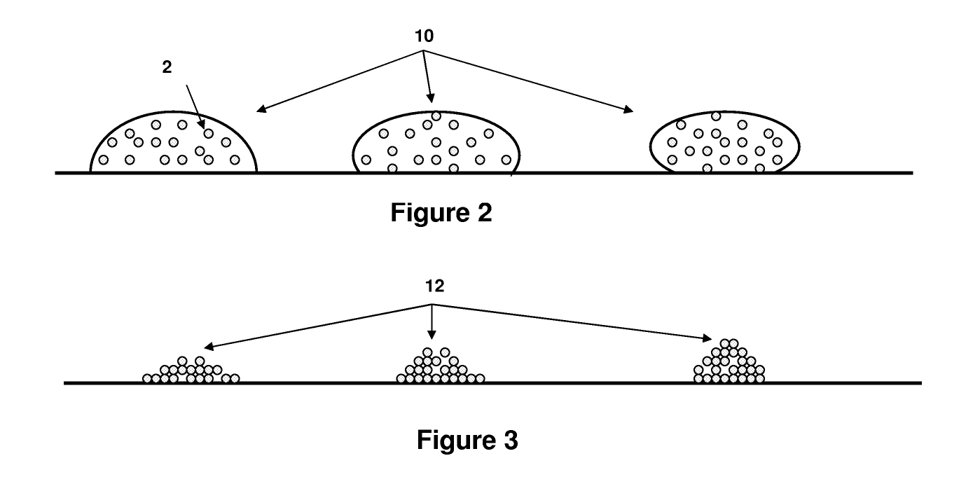

While the invention has been explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims. FIG. 1 shows the dynamics of droplet impact with a hydrophobic surface. In A, known particles 2 (circles) alone or with known non-film-forming spreaders (curved lines) 4 are in a slurry droplet 6. Impact with a surface causes droplets 8 to shatter and resist spreading and/or not remain on the surface. The remaining droplet(s) 10 retract and are not well bound to or captured by the surface resulting in a spotty dry film 12 with low deposition of particles 12. In B, the present composition comprises particles 2 plus the present film-forming spreading agent(s) (curved lines) 14 in a slurry droplet. The present film-forming spreading agent's long chains control expansion of droplet 16 and prevent shatter at impact. The present film-forming spreading agent 14 prevents retraction of droplet 18 by binding to the target surface and forming a thicker and more uniform dry particle film 20 with high deposition of particles. FIGS. 2 and 3 represent known non-spreading films. Delivering particles 2 alone in slurry without a spreading agent causes poor delivery of the particles 2 to the target surface due to droplets 10 that spot. During the drying process, the droplet 10 retracts and forms an uneven, domed, or spotty deposit 12 that is smaller in area than the wet droplet. Additionally, subsequent depositions migrate to the spots and further the spotting effect.

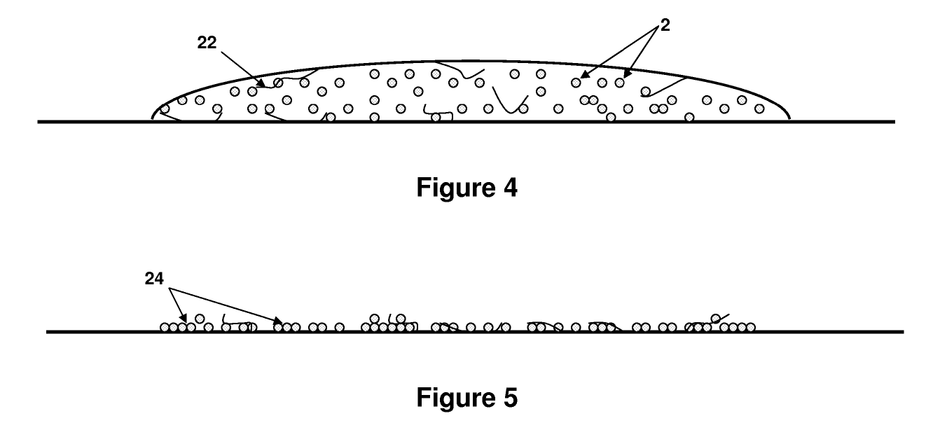

FIGS. 4 and 5 show known overspreading films. Distribution of particles 2 can be accomplished with the addition of a conventional spreader 22 but upon drying results in a very thin film 24 that is spotty or has gaps between particles 2 because of overspreading and running.

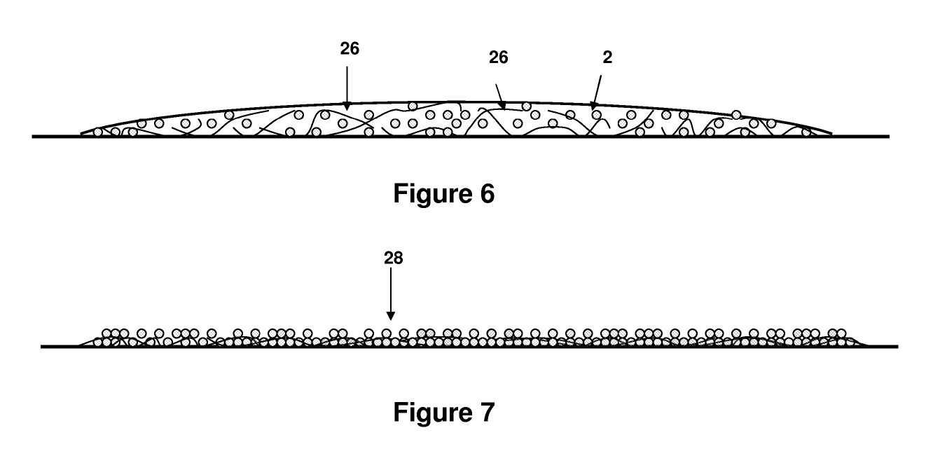

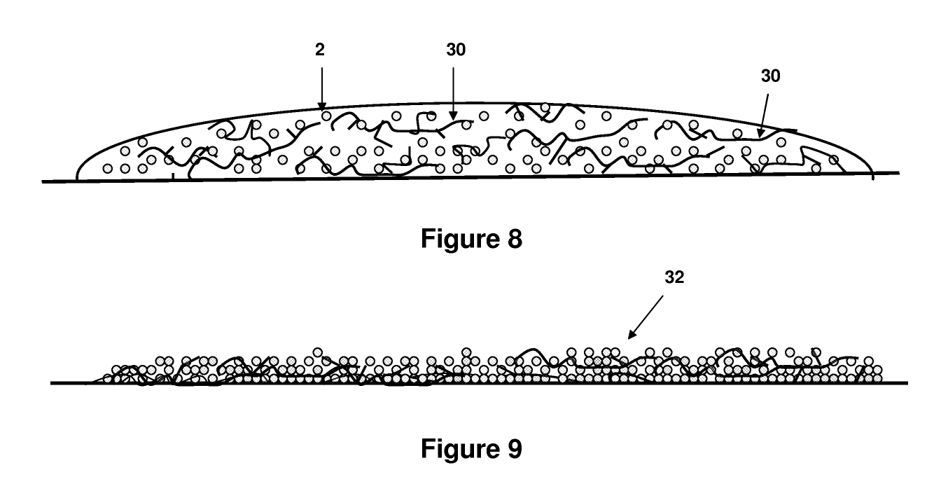

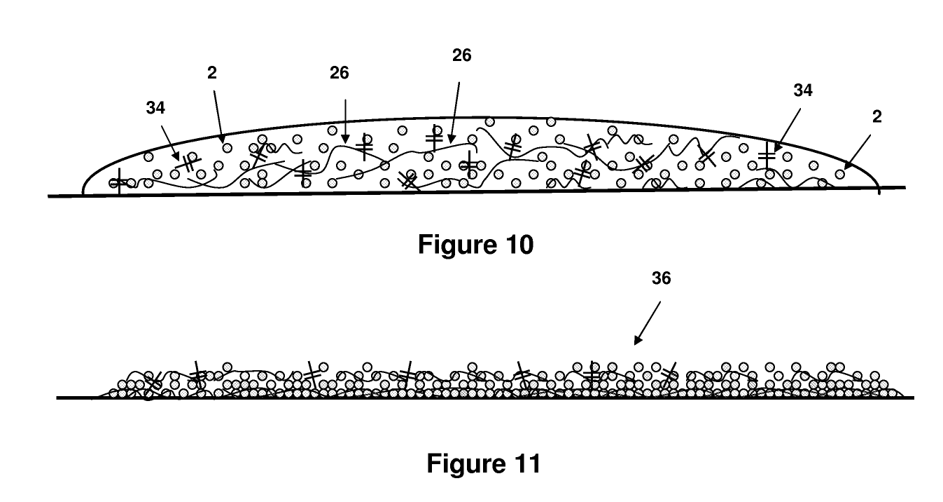

FIGS. 6 and 7 show film-forming spreading with the present film-forming spreading agent. One preferred example of the present film-forming spreading agent is high molecular weight polyvinyl alcohol. The high molecular weight polyvinyl alcohol 26 chemically binds with the particles 2 and target surface to hold the particles 2 together during the drying phase to form a uniform film 28. FIGS. 8 and 9 show film-forming spreading and volumizing of particles 2 with a present film-forming spreading agent that is also capable of volumizing 30. One preferred example is high molecular weight hydroxypolymer. The high molecular weight hydroxypolymer 30 is capable of both film-forming spreading and volumizing by chemically binding with the particles 2 and target surface. This increases film thickness and prevents retraction of the droplet during the drying phase to form a thick and uniform film 32 without marked gaps. FIGS. 10 and 11 show film-forming spreading with the present high molecular weight polyvinyl alcohol 26 and a volumizing agent that cannot spread on a hydrophobic surface by itself. The high molecular weight polyvinyl alcohol 26, for example, plus a volumizing agent that cannot spread on a hydrophobic surface on its own 34, chemically binds with the particles 2 and target surface to increase film thickness and prevents retraction of the droplet during the drying phase to form a thick and uniform film 36.

In FIGS. 12 through 15, the particle used was ASP-602 hydrous kaolin from Engelhard Corporation (now BASF Catalysts LLC).

In FIG. 12, the film-forming spreading agent used was high molecular weight (5K) high viscosity (4-8 m.Pas) cellulose. This viscosity of specification was measured at 2% on Brookfield RVT at 20° C., m.Pas. The molecular weight range was approximately 30,000-40,000 Daltons. A present composition comprising hydrous kaolin and the cellulose was added to water to form a slurry of 6% formulation solids (w:w) in water. The slurry was sprayed on a variety of natural and synthetic target surfaces that ranged in degrees of hydrophobicity. Surfaces (top to bottom) include apple fruit, eggplant fruit, apple leaf, pear leaf, and polyethylene plastic. The film-forming spreading agent concentration ranged from 0.1 to 1.0% (w:w) concentration to hydrous kaolin as follows: column A=0.1%, column B=0.3%, column C=0.5%, column D=0.7%, and column E=1.0%. Universal film-forming spreading was achieved on all surfaces at 0.5% (w:w) high viscosity cellulose to kaolin. Fingerprints accidentally disrupted the film on the 0.3 to 1.0% plastics.

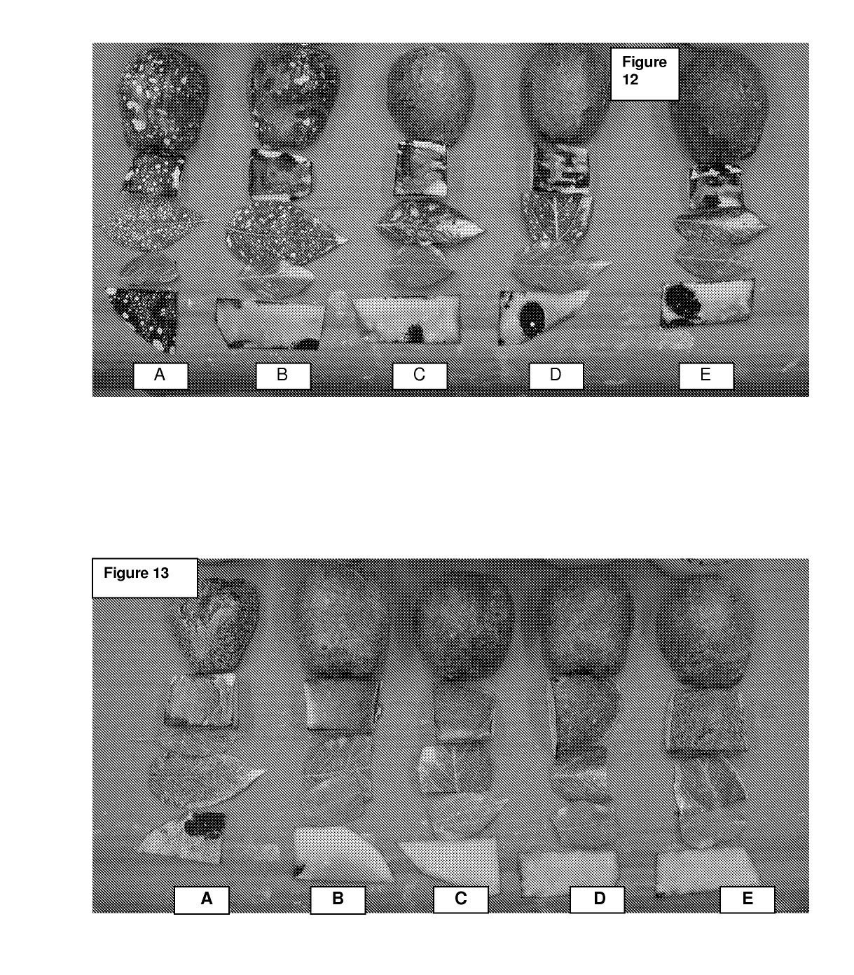

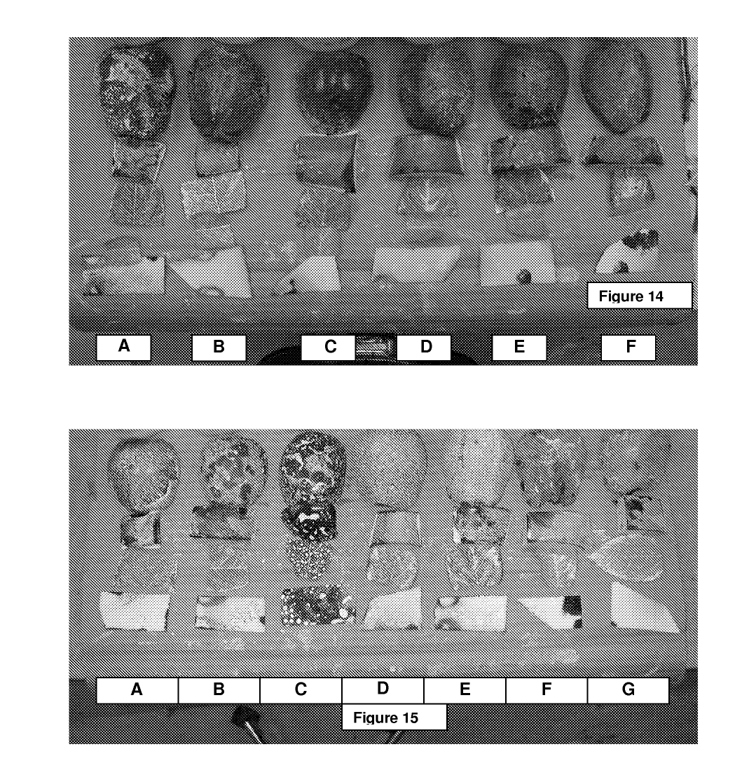

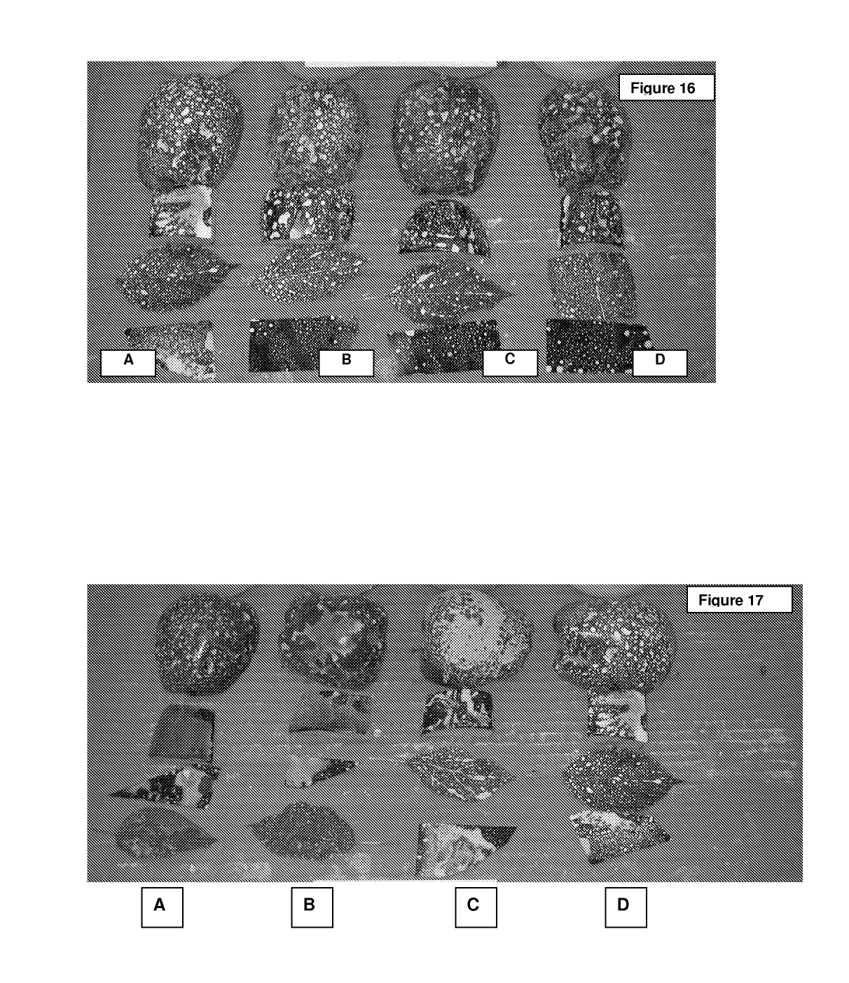

In FIG. 13, the film-forming spreading agent used was high molecular weight (65K) super high viscosity (58,000-70,000 m.Pas) cellulose. This viscosity of specification was measured at 2% on Brookfield RVT at 20° C., m.Pas. The molecular weight range was approximately 1,000,000 Daltons. A present composition comprising hydrous kaolin and the cellulose was added to water to form a slurry of 6% formulation solids (w:w) in water. The slurry was sprayed on a variety of natural and synthetic target surfaces that ranged in degrees of hydrophobicity. Surfaces (top to bottom) include apple fruit, eggplant fruit, apple leaf, pear leaf, and polyethylene plastic. The film-forming spreading agent concentration ranged from 0.1 to 1.0% (w:w) concentration to hydrous kaolin as follows: column A=0.1%, column B=0.3%, column C=0.5%, column D=0.7%, and column E=1.0%. Universal film-forming spreading was achieved on all surfaces at 0.3% (w:w) high viscosity cellulose to kaolin. Fingerprints accidentally disrupted the film on the 0.1% plastics.

In FIG. 14, the film-forming spreading agent used was high molecular weight (85-250K) partially hydrolyzed polyvinyl alcohol. The viscosity specification was measured at 4% is stated to be 25.00+/−2.00 cP to 50.00+/−5.00 cP. The molecular weight range was approximately 85,000-250,000 Daltons. A present composition comprising hydrous kaolin and the cellulose was added to water to form a slurry of 6% formulation solids (w:w) in water. The slurry was sprayed on a variety of natural and synthetic target surfaces that ranged in degrees of hydrophobicity. Surfaces (top to bottom) include apple fruit, eggplant fruit, apple leaf, pear leaf, and polyethylene plastic. The film-forming spreading agent concentration ranged from 0.1 to 1.0% (w:w) concentration to hydrous kaolin as follows: column A=0.1%, column B=0.3%, column C=0.5%, column D=0.7%, column E=1.0%, and column F=1.5%. Universal film-forming spreading was achieved on all surfaces at 0.3% (w:w) high viscosity cellulose to kaolin. Fingerprints accidentally disrupted the film on the 0.1% plastics.

In FIG. 15, the film-forming spreading agent used was high molecular weight (85-250K) polyvinyl alcohol. The viscosity specification was measured at 4% is stated to be 25.00+/−2.00 cP to 50.00+/−5.00 cP. The molecular weight range was approximately 85,000-250,000 Daltons. A present composition comprising hydrous kaolin and the cellulose was added to water to form a slurry of 6% formulation solids (w:w) in water. The slurry was sprayed on a variety of natural and synthetic target surfaces that ranged in degrees of hydrophobicity. Surfaces (top to bottom) include apple fruit, eggplant fruit, apple leaf, and polyethylene plastic. The film-forming spreading agent concentration was: column A=0.63%, column B=0.63%, column C=0%, column D=1.75%, column E=1.25%, column F=1.25%, and column G=1.75%. The volumizing agent concentration was: column A=0.32%, column B=0%, column C=0.32%, column D=1.25%, column E=1.25%, column F=0%, and column G=0%.

The results of this FIG. 15 show that superior film-forming spreading and deposition results can be achieved when a volumizing agent that does not spread on hydrophobic surfaces (animal glue) is present with high molecular weight polyvinyl alcohol. Note that column A is superior to column B. Column C which contains only the volumizing agent that does not spread on hydrophobic surfaces (animal glue) and has a poor deposition.

Column D and E are also superior to G and F respectively which contain no volumizing agent that does not spread on hydrophobic surfaces (animal glue).

In addition, the amount of high molecular weight polyvinyl alcohol needed can be lower with equal-to-superior results when a volumizing agent that does not spread on hydrophobic surfaces (animal glue) is present. This is seen in the equal-to-superior results of column E versus column D.

In FIG. 16, known particles from Engelhard Corporation (now BASF Catalysts LLC) were used—Surround® WP crop protectant (column A), unformulated calcined kaolin (column B), unformulated hydrous kaolin of a pre-dispersed type (column C), and an unformulated hydrous kaolin of an acid type (column D). No spreading agent or volumizing agent was added. Each particle type was added to water to form a slurry of 6% formulation solids (w:w) in water. The slurry was sprayed on a variety of natural and synthetic target surfaces that ranged in degrees of hydrophobicity. Surfaces (top to bottom) include apple fruit, eggplant fruit, apple leaf, and polyethylene plastic. Film-forming spreading was not achieved on any of these surfaces. In FIG. 17, known particles were used—Snow hydrous kaolin from Wilbur-Ellis (column A), Crop White hydrous kaolin from Monterrey Chemical (column B), Sun Guard hydrous kaolin from Sun-Guard Chemical Co. (column C), and Surround® WP crop protectant from Engelhard Corporation (column D). No spreading agent or volumizing agent was added. Each particle type was added to water to form a slurry of 6% formulation solids (w:w) in water. The slurry was sprayed on a variety of natural and synthetic target surfaces that ranged in degrees of hydrophobicity. Surfaces (top to bottom) include apple fruit, eggplant fruit, apple leaf, and polyethylene plastic. Film-forming spreading was not achieved by any of these materials on any of these surfaces.

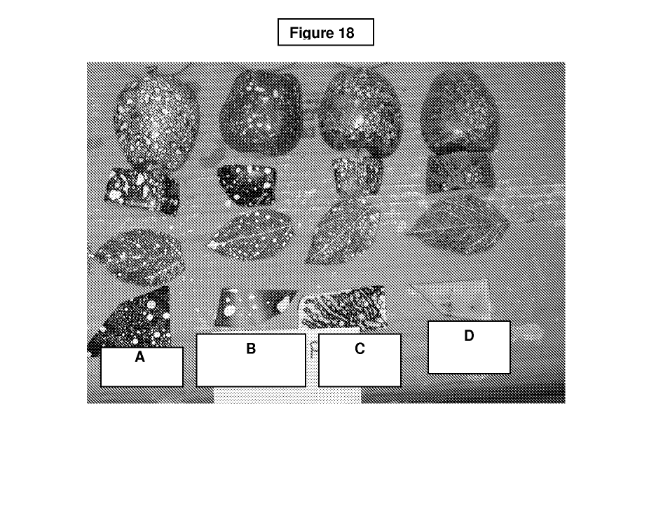

FIG. 18 is published prior art of mineral-based whitewash materials used on plant and plastic surfaces. Note that spreading was only achieved by kaolin plus the high rate (0.25%) a surfactant on apple and eggplant but resulted in uncontrolled spreading that resulted in excessive run-off of the spray material. Film-forming spreading was not achieved on all of these surfaces with any material. Column A is Kaolin hydrous kaolin+polyethylene oxide at 0.1%. (Daimes 1957, Marco 1994; Bergeron, 2001). Column B is Kaolin hydrous kaolin+Polyacrylamide at 0.1%. (Bergeron, 2001). Columns C and D are two examples of Kaolin hydrous kaolin+0.025 and 0.25% anionic surfactant respectively. (Yokomi et al. 1981, Bar Joseph 1983)

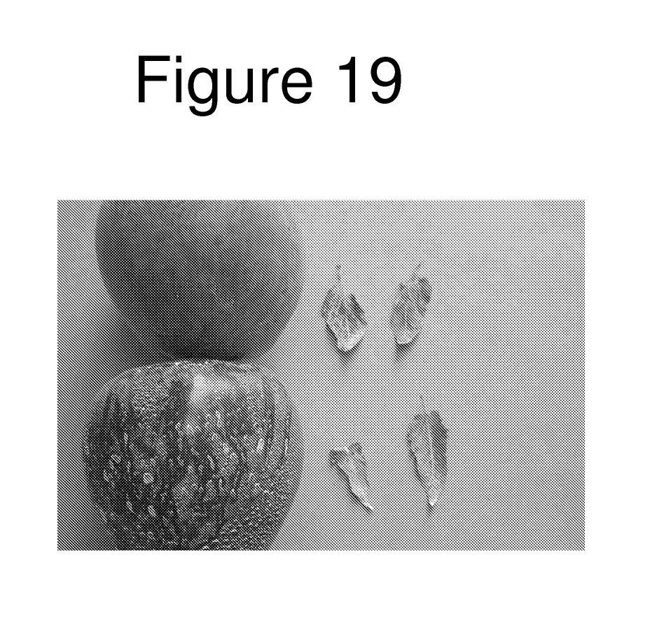

FIGS. 19 to 26 show applications made on a Red Delicious apple (left) and tomato leaves (right). The Red Delicious surface is hydrophobic while tomato leaves are hydrophilic. Some plants such a tomato and grapes have hydrophobic fruit and hydrophilic leaves. It is desirable to spread evenly on both surfaces.

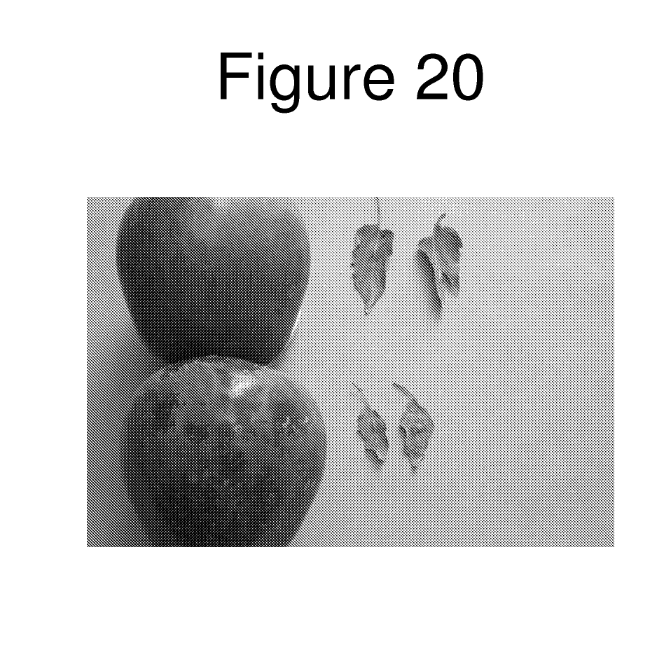

FIGS. 19 and 20 show the current art of applications of plain kaolins with a commercial spreader. In all cases, film formations are extremely thin on both the apple and tomato leaves. FIG. 19 shows calcined kaolin with high (top) and low (bottom) levels of commercial spreader. FIG. 20 shows hydrous kaolin with high (top) and low (bottom) levels of commercial spreader. Note that the films can barely be seen in FIG. 20.

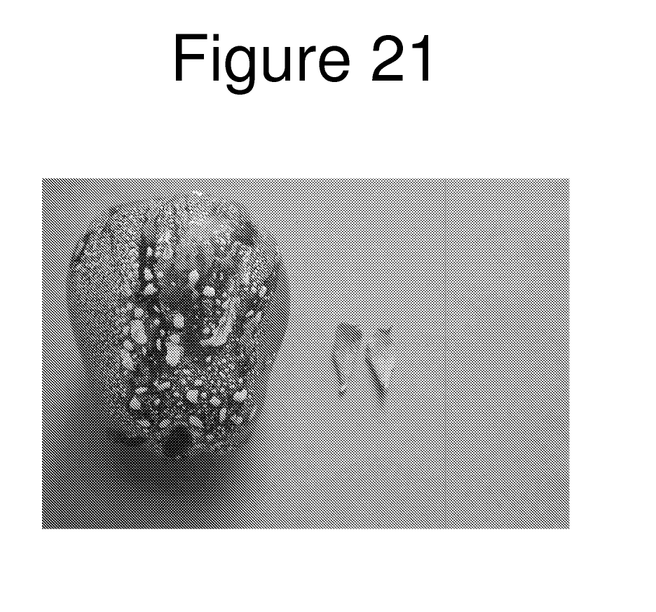

FIG. 21 shows the commercial prior art Surround WP crop protectant. The apple does not show film-forming spreading but the tomato leaves have good film build.

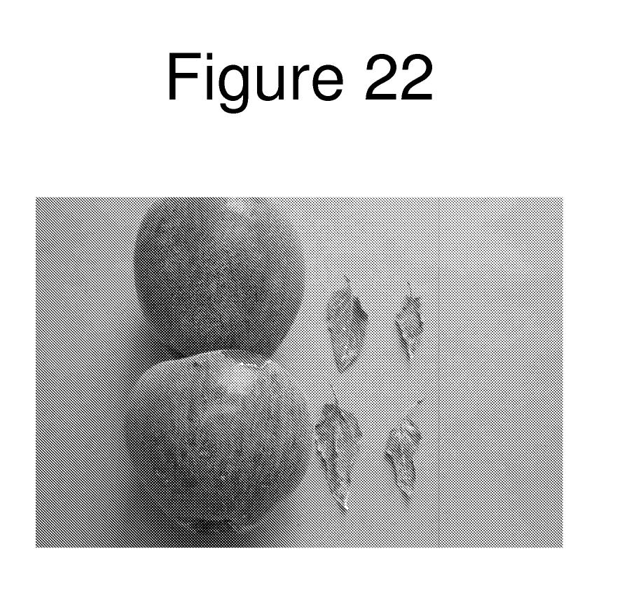

FIG. 22 shows Surround WP crop protectant with high (top) and low (bottom) levels of commercial spreader. Both show improved, but thin, spreading on the apples while the tomato leaves now have a very thin film.

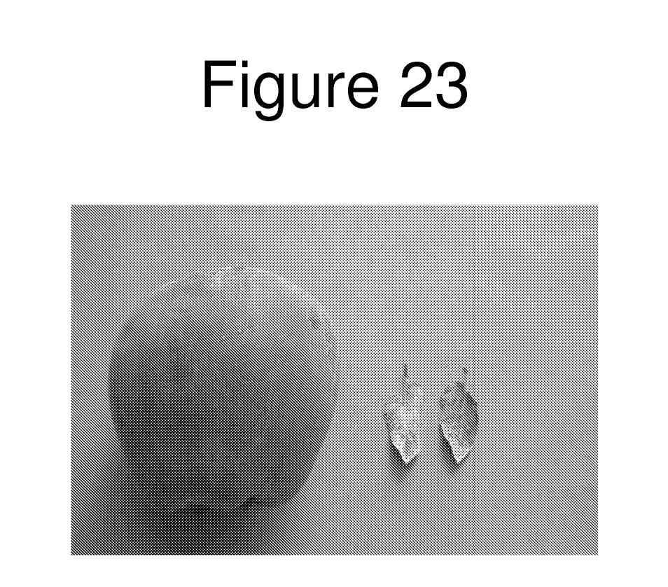

FIG. 23 shows inventive film-forming spreading using HMW-PVOH. The film build on both the apple and tomato are improved versus FIGS. 19, 20, 21, and 22. Note the even coating on the two different types of surfaces.

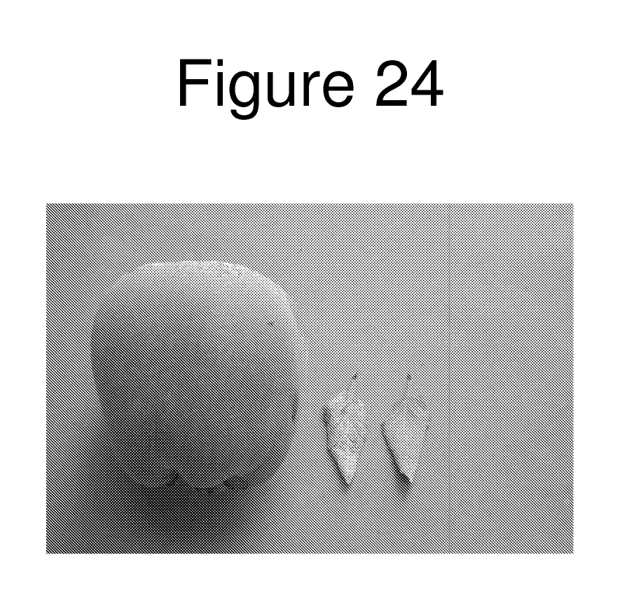

FIG. 24 shows inventive film-forming spreading using cellulose that can both spread and volumize. There is improved, and even, film build over FIGS. 19, 20, 21, 22, and 23 on both surfaces.

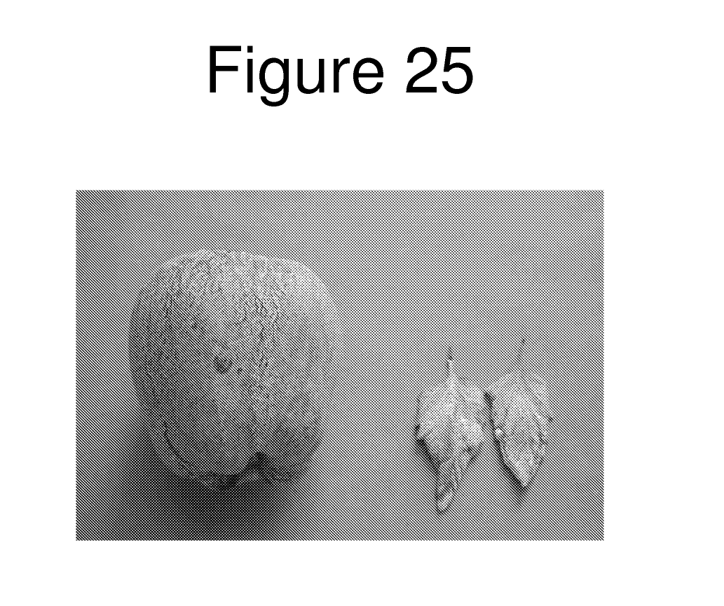

FIG. 25 shows inventive film-forming spreading using PVOH and avolumizer that does not spread on hydrophobic surfaces by itself. Note the heavy build versus FIGS. 19, 20, 21, 22, 23, and 24 on both surfaces.

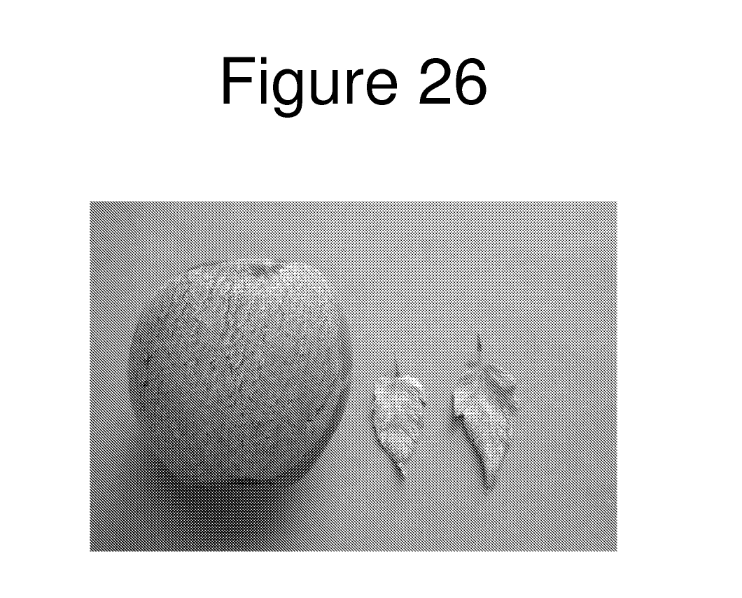

FIG. 26 shows inventive film-forming spreading using the composition of FIG. 25 but substituting 50% of the calcined kaolin with hydrous kaolin. Film build on both surfaces is improved over FIGS. 19, 20, 21, 22, and 23 and is comparable to FIGS. 24 and 25.

Spreading values were determined for the above Figures by visual inspection and a rating assigned as follows: 1=no spread or film, 2=intermediate spread or film, and 3=complete spread or film. The results are in Tables 1 and 2 below where HMPC stands for hydroxyl methyl propyl cellulose and PVOH stands for polyvinyl alcohol.

TABLE 1

| | | Spreading value on various target surfaces | | | | | | |
|---|---|---|---|---|---|---|---|---|
| | Molecular Wt. | Conc. of | | | | | Poly- | Mean spread |
| | Viscosity | hydroxy- | Apple | Egg | Apple | Pear | ethylene | value over |
| Treatment | (Daltons) | polymer | Fruit | Plant | Leaf | Leaf | plastic | all surfaces |
| HMPC | 4-8 m · Pas | 0.1 | 1 | 1 | 3 | 1 | 1 | 1.4 |
| (FIG. 12) | (30,000-40,000 | 0.3 | 2 | 2 | 3 | 2 | 3 | 2.4 |
| | Daltons) | 0.5 | 3 | 2 | 3 | 2 | 3 | 2.6 |
| | | 0.7 | 3 | 2 | 3 | 2 | 3 | 2.6 |
| | | 1.0 | 3 | 3 | 3 | 3 | 3 | 3.0 |
| HMPC | 58,000-70,000 | 0.1 | 2 | 3 | 3 | 3 | 2 | 2.6 |
| (FIG. 13) | M · Pas | 0.3 | 3 | 3 | 3 | 3 | 3 | 3.0 |
| | (1,000,000 | 0.5 | 3 | 3 | 3 | 3 | 3 | 3.0 |
| | Daltons) | 0.7 | 3 | 3 | 3 | 3 | 3 | 3.0 |
| | | 1.0 | 3 | 3 | 3 | 3 | 3 | 3.0 |
| HMW-PVOH | 25-50 cP | 0.1 | 2 | 2 | 3 | 3 | 2 | 2.4 |
| (FIG. 14) | (85,000-250,000 | 0.3 | 3 | 3 | 3 | 3 | 3 | 3.0 |
| | Daltons) | 0.5 | 3 | 3 | 3 | 3 | 3 | 3.0 |
| | | 0.7 | 3 | 3 | 3 | 3 | 3 | 3.0 |
| | | 1.0 | 3 | 3 | 3 | 3 | 3 | 3.0 |
| | | 1.5 | 3 | 3 | 3 | 3 | 3 | 3.0 |

TABLE 2

| | | Spreading value on various target faces | | | | | | |
|---|---|---|---|---|---|---|---|---|
| | Molecular Wt. | Conc. of | | | | | Poly- | Mean spread |
| | Viscosity | hydroxy- | Apple | Egg | Apple | Pear | ethylene | value over |
| Treatment | (Daltons) | polymer | Fruit | Plant | Leaf | Leaf | plastic | all surfaces |
| HMW-PVOH | 25-50 cP | 0.32 + 0.63 | 3 | 3 | 3 | N/A | 3 | 3 |
| (FIG. 15) + | (85,000-250,000 | 0.32 + 0.00 | 2 | 2 | 3 | N/A | 3 | 2.5 |
| Thixotrope | Daltons) | 0.00 + 0.63 | 1 | 1 | 1 | N/A | 1 | 1 |
| | | 1.75 + 1.25 | 3 | 3 | 3 | N/A | 3 | 3 |
| | | 1.25 + 1.25 | 3 | 3 | 3 | N/A | 3 | 3 |
| | | 0.25 + 0.00 | 2.5 | 2.5 | 3 | N/A | 3 | 2.75 |
| | | 1.75 + 0.00 | 2.5 | 2.5 | 3 | N/A | 3 | 2.75 |
| Surround WP (FIG. 16) | N/A | N/A | 1 | 2 | 1 | N/A | 1 | 1.25 |
| Calcined Kaolin (FIG. 16) | N/A | N/A | 1 | 1 | 1 | N/A | 1 | 1 |
| Hydrous Kaolin | N/A | N/A | 1 | 1 | 1 | N/A | 1 | 1 |
| (Dispersed) (FIG. 16) | | | | | | | | |
| Hydrous Kaolin | N/A | N/A | 2 | 1 | 1 | N/A | 1 | 1.25 |
| (Acid) (FIG. 16) | | | | | | | | |
| Snow (FIG. 17) | N/A | N/A | 1 | 3 | 2 | N/A | 2 | 2 |
| Crop White (FIG. 17) | N/A | N/A | 2 | 2 | 2 | N/A | 1 | 1.75 |
| SunGuard (FIG. 17) | N/A | N/A | 2.5 | 2 | 1 | N/A | 2 | 1.75 |
| Surround WP (FIG. 17) | N/A | N/A | 1 | 2 | 1 | N/A | 1 | 1.25 |
| Kaolin + | N/A | N/A | 1 | 1 | 1 | N/A | 1 | 1 |
| Polyethylene Oxide | | | | | | | | |
| (FIG. 18) | | | | | | | | |
| Kaolin + | N/A | N/A | 1 | 1 | 1 | N/A | 1 | 1 |
| Polyacrylamide (FIG. 18) | | | | | | | | |
| Kaolin + 0.025% | N/A | N/A | 2 | 1.5 | 1 | N/A | 1 | 1.38 |
| Surfactant (FIG. 18) | | | | | | | | |
| Kaolin + 0.25% | N/A | N/A | 2 | 2 | 3 | N/A | 3 | 2.5 |
| Surfactant (FIG. 18) | | | | | | | | |

### INVENTIVE EXAMPLE 1

A sample of particle product is prepared by dry blending a particulate mineral, preferably kaolin with 1% w/w hydroxyl polymer. The product is then added to water at a level of 6% solids concentration. The sample is mixed to allow solvation and activation of the hydroxyl polymer and dispersion of the particulate mineral. The sample is then applied, preferably through conventional spray application means to a substrate at a spray volume sufficient to form a film on the target surface. The application is then allowed to dry. This is depicted in FIG. 24. Subsequent applications can be sprayed to increase deposited volume or to repair areas where the deposition is not present.

### INVENTIVE EXAMPLE 2

A sample of particle material product is prepared by dry blending a particle, preferably kaolin clay with 1% w/w hydroxyl polymer. The product is then added to water at a level of 6% solids concentration. The sample is mixed to allow solvation and activation of the hydroxyl polymer and dispersion of the particle. The sample is then beaten or whipped to introduce air and to form a cream or paste. The sample is then applied, preferably by brushing or rubbing to a substrate in a means sufficient to form a film on the target surface. The application is then allowed to dry. Subsequent applications can be re applied to increase deposited volume or to repair areas where the deposition is not present.

### INVENTIVE EXAMPLE 3

A sample of particle material product is prepared by dry blending a particle, preferably calcined kaolin with 1.75% w/w HMW-PVOH. The product is then added to water at a level of 6% solids concentration. The sample is mixed to allow salvation and activation of the hydroxyl polymer and dispersion of the particle. The sample is then applied, preferably through conventional spray application means to a substrate at a spray volume sufficient to form a film on the target surface. The application is then allowed to dry. This is depicted in FIG. 23. Subsequent applications can be re applied to increase deposited volume or to repair areas where the deposition is not present.

### INVENTIVE EXAMPLE 4

A sample of particle material product is prepared by dry blending a particle, preferably calcined kaolin, with 1.25% HMW-PVOH and 1.25% animal glue. The product is then added to water at a level of 6% solids concentration. The sample is mixed to allow salvation and activation of the hydroxyl polymer and dispersion of the particle. The sample is then applied, preferably through conventional spray application means to a substrate at a spray volume sufficient to form a film on the target surface. The application is then allowed to dry. This is depicted in FIG. 25. Subsequent applications can be re applied to increase deposited volume or to repair areas where the deposition is not present.

### INVENTIVE EXAMPLE 5

A sample of particle material product is prepared by dry blending calcined kaolin and hydrous kaolin particles at 50% each with 1.25% HMW-PVOH and 1.25% animal glue. The product is then added to water at a level of 6% solids concentration. The sample is mixed to allow salvation and activation of the hydroxyl polymer and dispersion of the particle. The sample is then applied, preferably through conventional spray application means to a substrate at a spray volume sufficient to form a film on the target surface. The application is then allowed to dry. This is depicted in FIG. 26. Subsequent applications can be re applied to increase deposited volume or to repair areas where the deposition is not present.

### INVENTIVE EXAMPLE 6

A sample of particle material product is prepared by dry blending hydrous kaolin particles with 0.4% w/w hydroxyl polymer. The product is then added to water at a level of 6% solids concentration. The sample is mixed to allow solvation and activation of the hydroxyl polymer and dispersion of the particle. The sample is then applied, preferably through conventional spray application means to a substrate at a spray volume sufficient to form a film on the target surface. The application is then allowed to dry. Subsequent applications can be re applied to increase deposited volume or to repair areas where the deposition is not present.

### INVENTIVE EXAMPLE 6

A sample of particle material product is prepared by dry blending hydrous kaolin particles 0.63% HMW-PVOH and 0.32% animal glue. The product is then added to water at a level of 6% solids concentration. The sample is mixed to allow solvation and activation of the hydroxyl polymer and dispersion of the particle. The sample is then applied, preferably through conventional spray application means to a substrate at a spray volume sufficient to form a film on the target surface. The application is then allowed to dry. This is depicted in FIG. 15 column A. Subsequent applications can be re applied to increase deposited volume or to repair areas where the deposition is not present.

What is claimed:

1. A composition comprising:
(a) 99.80% by weight or less of at least one particle;
(b) film forming spreading agent present in an amount of: (i) equal to or greater than 0.20% by weight if a spreader inhibitor is not present or (ii) equal to or greater than about 0.35% by weight if a spreader inhibitor is present; and optionally (c) at least one volumization agent.

2. The composition of claim 1 wherein said film forming spreading agent (b)(i) is present.

3. The composition of claim 1 wherein said film forming spreading agent (b)(ii) is present.

4. The composition of claim 1 wherein said film forming spreading agent (b) is in dry form.

5. The composition of claim 1 wherein said particle (a) is a mineral.

6. The composition of claim 1 wherein said particle (a) is calcined kaolin or hydrous kaolin.

7. The composition of claim 1 wherein said particle (a) is calcium carbonate.

8. The composition of claim 1 wherein said film forming spreading agent (b) is a water soluble hydroxypolymer containing one hydrophobic group or lipophilic group per repeating unit of said hydroxypolymer.

9. The composition of claim 1 wherein said film forming spreading agent (b) is a modified hydroxypolymer crosslinked with crosslinking agents.

10. The composition of claim 1 wherein said film forming spreading agent (b) is a cross-linked polymer.

11. The composition of claim 1 wherein said film forming spreading agent (b) is high molecular weight polyvinyl compound having an average molecular weight of at least about 85,000 Daltons or a minimum viscosity of about 25 to 50 centipoises ±5 cps measured at 4 percent w/w polyvinyl alcohol concentration in water.

12. The composition of claim 1 wherein said film forming spreading agent (b) is high molecular weight cellulose defined as having an average measured viscosity for a 2% solution of at least about 1.0 millipascals/second® 20° C.

13. The composition of claim 1 wherein said film forming spreading agent (b) is a volumization agent also.

14. The composition of claim 13 wherein said film forming spreading and volumization agent is high molecular weight celluloses defined as having an average measured viscosity for a 2% solution of at least about 1.0 millipascals/second® 20° C.,

15. The composition of claim 13 wherein said film forming spreading and volumization agent is modified cellulose crosslinked with crosslinking agents.

16. The composition of claim 1 additionally comprising at least a volumization agent (c).

17. The composition of claim 16 wherein said volumization agent (c) is selected from the group consisting of gelatin, polyacrylamides, polyamines, polyacrylates, polydiallydimethylammonium chloride, epichlorohydrin-dimethylamine, and mineral.

18. The composition of claim 16 wherein said volumization agent (c) is gelatin or animal glue.

19. The composition of claim 1 wherein said particles (a) comprise a blend of two different particles.

20. The composition of claim 19 wherein said blend is calcined clay and hydrous clay.

21. The composition of claim 20 wherein said clay is kaolin.

22. An agricultural composition comprising the composition of claim 1.

23. A film comprising said agricultural composition of claim 22.
